(19) United States
(12) Patent Application Publication
(10) Pub. No.: US 2005/0203800 A1
(43) Pub. Date: Sep. 15, 2005

(54) System and method for compounded marketing

(76) Inventors: Duane Sweeney, Bellingham, WA (US); Stephanie Hopkinson, Deming, WA (US); Harry Rosenberg, Ingomar, PA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/033,250

(22) Filed: Jan. 7, 2005

Related U.S. Application Data
(63) Continuation-in-part of application No. 10/763,635, filed on Jan. 22, 2004.
(60) Provisional application No. 60/441,974, filed on Jan. 22, 2003.

(51) Int. Cl. G06F 17/60

(52) U.S. Cl. 705/14

(57) ABSTRACT

A system and method to facilitate computer-based commerce is presented. The system includes a module to facilitate communicating a vendor offering to a user if the offering is within a category designated by the user as being acceptable for receipt of such offering. The provider offering includes a category code to indicate an associated category for the provider offering. If a user chooses to propagate a vendor offering to another user, the user may be entitled to a reward. The reward may be designated to the user or to a third party. A spam control module may also be provided to identify spam complaints and to take actions in response to the spam complaints.

The present application is a continuation-in-part of U.S. patent application Ser. No. 10/763,635 entitled “SYSTEM AND METHOD FOR COMPOUNDED MARKETING,” filed Jan. 22, 2004, which, in turn, claims the benefit of the filing date of U.S. provisional patent application Ser. No. 60/441,974 entitled “SYSTEM AND METHOD FOR COMPOUNDED MARKETING,” filed Jan. 22, 2003. Said applications are incorporated herein by reference.

### FIELD

This invention relates generally to the field of data communications, and more particularly, to a system and method for compounded marketing.

### BACKGROUND

It wasn't too long ago that advertising a product or service took only a loud voice and strong lungs. Attempts have been made by retailers to regain the intimacy and the relevant dialogue of the smaller community. One example is customer lists developed by retailers using purchase histories. These are routinely used to target consumers according to purchase history. While this has met with some success, it still fails to meet the objective of matching a product or service with a consumer's current need—the retailer is sending out advertisements based on past purchases to a customer who may no longer have a need for that particular type of product.

The Internet is changing some of these paradigms. Internet users actively search for what they want or need. They are not so eager to have a “commercial” take over their screens for even 30 seconds. In like manner, consumers find spam (unwanted e-mail) that fills their e-mail in-boxes annoying. There is a need to provide a better means to identify probable customers for a given item of merchandise and to change the relationship between consumers and producers, giving consumers more power and choice over their exposure to advertising.

### SUMMARY

According to one aspect of the present invention, there is a system and method provided to facilitate computer-based commerce. The system includes a module to facilitate communicating a vendor offering to a user if the offering is within a category designated by the user as being acceptable for receipt of such offering. The provider offering includes a category code to indicate an associated category for the provider offering. If a user chooses to propagate a vendor offering to another user, the user may be entitled to a reward.

### BRIEF DESCRIPTION OF THE DRAWINGS

The present invention is illustrated by way of example and not limitation in the figures of the accompanying drawings, in which like references indicate similar elements and in which:

FIG. 1 is a network diagram depicting a system having a client-server architecture, according to one exemplary embodiment of the present invention.

FIG. 2 is a block diagram illustrating a compounded communication system to facilitate computer-based commerce utilizing compounded communication, according to one exemplary embodiment of the present invention.

FIG. 3 is a flow chart illustrating a method to facilitate computer-based commerce utilizing compounded communication, according to one exemplary embodiment of the present invention.

FIG. 4 is a flow chart illustrating a method to facilitate computer-based commerce utilizing compounded communication, characterized by two distinct entry portals, according to one exemplary embodiment of the present invention.

FIGS. 5A-5E illustrate a block diagram illustrating components to facilitate interaction between different participants in the compounded communication system, according to one exemplary embodiment of the present invention.

### DETAILED DESCRIPTION

The proposed compounded (or affiliate) marketing system uses affiliates to find and refer appropriate prospects. The system may be implemented to provide consumers with more power and choice over their exposure to commercial and non-commercial offerings and to facilitate propagation of desirable offerings within a community of consumers. This may be accomplished by assigning a category to each offering that passes through the system and enabling a user to only invite and receive offerings of particular categories (interest categories) and to prevent receipt of all other offerings. In order to receive only such offerings that may be of interest to the user and to gain immediate access to such offerings, the user may select one or more interest categories from a list of categories provided by the system. The user may also designate a category according to the user's level of interest in that category (e.g., most interested, somewhat interested, and not at all interested). There may be a default designation, giving permission for the system to send information from categories not explicitly designated as unacceptable by the user, if the system determines that the user may be interested in information and/or offers from them based on other behavior or selections. A selection of categories may be maintained in a user profile (also referred to as an interest profile), which is also maintained by the system. In operation, when an offering is submitted to the system by a provider, the system assigns an interest category to the offering and attaches a category code to every communication (e.g., an affiliated communication such as an affiliated e-mail) containing the offering. The system further compares the category codes attached to the communication with the list of categories in the user profile. The communication is sent to a particular user only if a category code attached to the communication matches one of the categories in the user profile.

While categorization allows the users to control the nature of offerings to be received and to be blocked, the system, in one embodiment, also encourages the users of the system to further propagate the offerings to potentially interested recipients by providing and managing a rewards system. In the context of this disclosure, a technique that facilitates propagation of offerings is referred to as “compounding.”

In one embodiment, the offerings may be propagated through the system (as well as from the system) vian affiliated communications (compounded marketing messages), such as e-mail messages, instant messages, and other forms of communication. A compounded marketing message may include an affiliated link to connect a recipient of the message to the compounded marketing system and, specifically, to one or more particular categories and/or one or more specific offerings. It will be noted that compounded marketing communications (e.g., affiliated communication) may be initiated at a central hub. The hub component of the compounded marketing system may also be responsible for categorizing the offerings, accessing user profiles, and determining whether a particular affiliated communication could be set to a particular user based on that user's profile. The hub may be physically unified or dispersed.

In one embodiment, the compounded marketing system may encompass: (i) peer-to-peer marketing, where individuals send commercial and other messages to their personal contacts; (ii) payment for results, where referral fees for sales or other measurable actions are tracked through affiliate software and paid to participants, which may be a multi-tier system; and (iii) database tracking of personal preferences as provided by participants, where personal and interest profiles facilitate appropriate contacts and protect against unwanted contacts.

This form of advertising may be utilized for electronically accessed products such as software, e-books, music, movies, instructional courses, etc. Such delivery would incur little cost except bandwidth associated with delivery, and payment is usually received before delivery, so limiting the number of sales is unnecessary. The publishers could reach their market nearly instantaneously and permanently. For instance, a promotion for a book on childbirth could go out on this system and immediately reach everyone with pregnancy or childbirth related options selected in his or her profile. Then it could be forwarded to everyone each of these users know who is expecting, and this process could be repeated for many generations as new users open up their profiles and people who know them and the book send the ad to them.

In an exemplary embodiment this system may be a hybrid of word of mouth recommendations; personal connections augmented with database completeness, accuracy, speed and ease of use; affiliate programs, providing personal earnings or the ability to donate to others; e-mail; modular assembly of messages and web pages, and other elements.

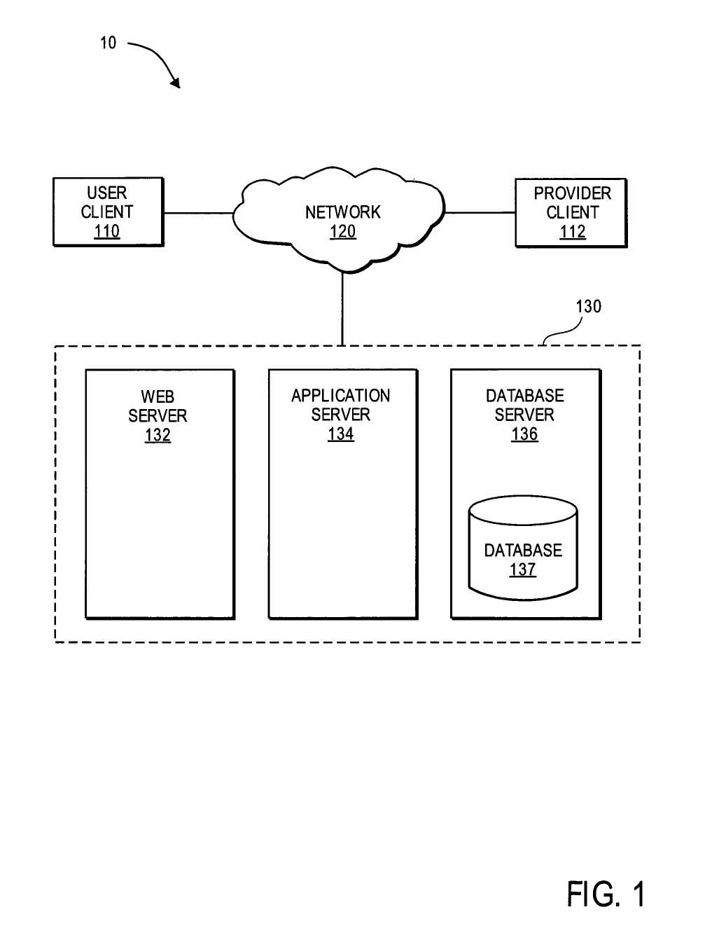

FIG. 1 is a network diagram depicting a system 10 having client-server architecture. The system 10 includes a user client 110, a provider client 112, a network 120, and a compounded marketing system 130. The system 130 may include one or more servers, which may be physically co-located or distributed in a distributed computing architecture (e.g., a compounded marketing Web server 132, a compounded marketing application server 134, and a compounded marketing database server 136).

The user client 110 is a computer system that enables a user (e.g., a potential recipient of a provider offering) to receive offerings generated by a provider at the provider client 112 and categorized by the compounded marketing system 130. The network 120 is a communications network, such as a LAN, WAN, intranet or the Internet. The compounded marketing system 130 may be hosting a compounded marketing Web site. The compounded marketing Web server 132 is a computer system that provides World Wide Web services, for example, to deliver Web pages using a markup language. The compounded marketing application server 134 is a computer system that provides support for whatever functions are required by compounded marketing system 130, such as receiving and processing transaction requests received by the compounded marketing system 130. The compounded marketing database server 136 is a computer system that stores and maintains tables or other data structures within the database 137 according to the specific architectural needs of the methods of the present invention, as described below. In one exemplary embodiment, the database 137 is a plurality of databases, such as a profiles database, an offerings database, and a categories database.

Users of the Compounded Marketing System

All persons interacting with or benefiting from the system 130 may fall into several categories of users depending on their particular relationship with the system 130. Users who have created an interest profile within the system may be referred to as members. A person or an entity with an agreement with the system in which they may earn commissions is considered to be an affiliate with respect to the system. An affiliate may earn commissions for referring individuals or other entities who make a purchase or being the proximate cause of other desired actions. A commission may be in a form of any benefit accruing to a party designated by the affiliate (e.g., a payee) for producing a desired result for the provider. A payee may be any individual or organization to whom commissions are directed. This may be an affiliate, a third party designated by the affiliate, or a third party designated in the packaged pieces of content (modules). Vendors may designate a third party or parties such as a charity or collection of charities or the user's choice of charity to receive a portion of proceeds earned by a module. A commission may be cash, credit, discount, donation to a third party, or any other good, service, or consideration of value, including simple recognition. For example, an affiliate who sends the affiliated communication to someone who buys the product or a service, may earn rewards in a form of money or credits. An affiliate may keep the rewards or assign the rewards to a person or entity of their choice. Anyone who responds to or forwards an affiliated communication, but is not a member or an affiliate is a participant. Participants do not earn commissions.

Another category of users is publishers. Publishers are provided by the system 130 with the ability to create publications (e.g., by combining modules with other information), from which they will earn commissions from every desired result generated, no matter how many generations of transmission occur or which module contained within the publication is responded to. A provider is a creator of any offering or content encapsulated in a module. A provider offering something for sale may be referred to as a vendor.

A publication is a second layer of modularization, containing one or more packaged pieces of content (modules), along with optional other content. It is tracked both as a single module, and each module within it may be tracked individually to generate appropriate rewards and statistics, but commissions may be assigned to the publisher as well as to the affiliate who most immediately forwarded the publication that was responded to. The publisher may receive commissions on sales or other rewardable actions related to the modules in the publication no matter how many transmissions or generations of transmission take place. Those who forward the publication may also receive rewards for action taken by those who receive it, again to any level of generations of transmission as set by the vendors in cooperation with the system of the present invention.

Information Modules

A publication may include one or more modules (also known as “ad modules” or “information modules”). A module is a piece of content packaged such that it can pass from one user to another without being altered. User identification may be added to a module to allow tracking and crediting of activity and/or rewards. Modules may be coded as to the type of content such that the code can be detected without anyone being exposed to the content. Modules can be encrypted and may be tracked as they pass through the system. A module may contain any type of content transmissible through e-mail or other electronic communication means, including commercial offerings with provision for placing orders. A module may contain one or more affiliated links.

Coding of information modules may include information useful to the user, information identifying or about the user in other ways, module tracking information, the categorization of the module, pointers to offers, data base record identifiers and the like. Preferably the user identification which accompanies all affiliated links and modules communicated by the user will be encrypted to prevent unauthorized uses. The coding may include human-readable elements so the addressee can get a quick idea of the content without opening the message, and can also sort communications bearing the same code into a mailbox for later review or discard. A multiplicity of information or ad modules containing material relating to the same specific topic or offering, differing in their presentation, size, or other variables may be referred to as a module family.

For example: An affiliated communication may be a combination of one or more modules and a message from, or at least the identification of, an affiliate, such that the system recognizes the affiliate and can track transmissions of the affiliated communication, along with responses to it (if any). The message may be whatever the affiliate sending it chooses. It may also be automatically generated in the case of automated forwarding, or institutional in the sense of being from the system itself or from the provider in the case of sending to lists of people or organizations which have selected the option to be the first recipients for affiliated communications related to specific topics (so called seed lists). Seed lists can be used to begin the communication cycle with a new affiliated communication. Providers may have their own seed lists from in-house e-mail subscriptions, or they can be generated within the affiliated communication system and made available for the use of providers releasing affiliated communications into the system.

An affiliate arrangement for a particular module may include a feature of persistent affiliation. This means that if a recipient responds to an affiliated communication sent by an affiliate, the commission relationship with that recipient established at that time will persist through time, under the conditions of the affiliate arrangement for that module. The length of time may be of any duration, or it may apply to certain sorts of transactions but not others, or all transactions, etc.

Each user may be supplied with or choose a unique user name, which allows other users to send them communications without knowing their actual e-mail address. In this way a recipient receiving all of her or his e-mail through the system can change e-mail addresses due to any reason, then update their system profile to reflect the new e-mail address and continue getting e-mail as before without having to notify anyone else of the new address. Messages would be forwarded to the user if the user has not blocked the sender or made other settings in their profile, which would stop the e-mail from being delivered. The user may require that, in order to be delivered, all communications sent through the system be categorized properly in accordance with the categorization coding system. Any communication not coded, not properly coded within the ability of the system to determine, or not in a desired category, would not be delivered, or, optionally, could be delivered with a warning as to the problem encountered. Users could be provided with the ability to automatically sort messages into storage by category, using a plug-in for their e-mail program, or as provided in the system's own e-mail facility. The system may inspect communications for good match between content and category, and block or identify as probable spam any not seeming to carry an appropriate identifying code, as well as the usual blocking if a communication does not carry a code for which the user is open to receiving information. The user may issue a “safe passage” code to trusted individuals to insure their communications pass through the system and reach the user safely. The system may also watch for patterns of communication sending which are identified as being related to spam techniques and respond as directed by the system administrator.

Free E-mail

Free e-mail provided to anybody is an optional part of the compounded marketing system 130. In this mode any person can establish a free e-mail account, allowing them to send and receive e-mail, and to establish and maintain a database of potential recipients. As is common practice, users of free e-mail may be exposed to various offerings and e-mail they send may include offerings or invitations or other information from the system, for example, in the form of listing the top few best selling items, or invitations to join the system to make money for a cause or individual one supports. With no further action, such users may or may not be eligible to receive affiliate income, to send affiliated communications, or to access some other features of the system. However, they may be able to establish interest profiles, both positive and negative. This gives any user an opportunity to eliminate or screen all affiliated communications coming to him/her through this system.

By becoming an affiliate, a user may still receive free e-mail services and in addition gain access to an affiliated communication creation area and possibly other privileges. Higher levels of results from affiliates may gamer them still higher levels of service, such as a larger e-mail storage space, advance notice of certain offerings, and official recognition in some fashion, such as the right to use a specific seal or symbol on their materials, and highlighted listings where appropriate.

Compounded (Affiliated) Communication

In one exemplary embodiment of the present invention, when users log in, they gain access to facilities allowing them to create affiliated communications. An affiliated communication may contain a personal message by the user, one or more affiliated links, as well as product or offering modules. An affiliated communication may also be coded, so that it can be tracked by the system, e.g., for the purpose of determining sender's eligibility for rewards. For example, when an affiliated link contained in the communication is activated by the recipient the system recognizes the original sender as the source, and if an action occurs which has been associated with a reward as a result of using the link, the original sender is credited with that reward. Rewards may be in a form of referral fees (e.g., commissions in the form of money) or in a form of referral credit (e.g., commission “banked” or reflected as a credit in the system).

In one embodiment, the only electronic messages eligible for reward upon achieving a desired response are those sent directly from the system. Messages forwarded from a user to another person without going through the system are not eligible for reward, as, for example, a spam prevention measure.

In a less controlled mode, responses to messages not sent directly from the system may be rewarded. Instead of employing the server-centric mode, users could forward messages and affiliated communication to another user or other users independently of the system, but otherwise according to the above in whole or in part. In this case the system would preferably reward the first user only after payment for sale or other rewardable action is received. This less controlled mode is not preferred at present because in the absence of completely effective anti-spam measures it may encourage the sending of unsolicited communication.

In one embodiment, the propagation of a message is effectuated while maintaining the fidelity of the message through any number of transmissions. Fidelity is maintained because affiliated communications only earn income if sent through the system hub, not if forwarded directly to a user's e-mail address and thus bypassing the hub. In this way the hub can check for acceptability by the addressee, then if it is acceptable or if the addressee is not registered send either the latest version of the message, if it has changed since the first user received it, or the system may send an invitation to register and create a profile if one does not exist. The outgoing message may also be blocked by the hub if it is an offer that has expired, for instance. A finder's fee may be payable to the person who transmits the message to another person who makes a purchase and/or makes other responses deemed valuable by the provider. The system may provide a positive cash flow for the seller, as credit card sales may fund the seller before they have to pay commissions to affiliates or to the compounded marketing system, or the system may handle the transaction and deduct its fees from the proceeds. Other features may include: built-in protection with spamming controls, a self-organizing structure that optimizes for efficient, thorough transmission to the whole online population interested in a given topic, quality assurance at every step with the community of members determining the quality of content, ancillary organizational features that are correlate of the basic structure, which have their own value and consequences (community web sites, for example); hardware and software to effect the above; networks to connect the various functional components; and means for triggering billing and shipping procedures both local and remote.

The compounded marketing system 130 may include a contact database with interest profiles; means for writing e-mails and optionally including voice and other types of communication; access to public parts of interest profiles created by anyone in the system; access to updates that are not public but are directed to an affiliate, either specifically as individuals or as a class, such as all those who have a particular e-mail address or contact in their contact database. Means to inspect the offerings may be available for an affiliate to include in an affiliated communication. This could be a database of such offerings that they can search. It may include automatic notification of new offerings in their area(s) of interest. Means to attach to, include with, or reference by the affiliate's e-mail one or more offering modules may be provided in such a way as to track their contribution to the result desired by the provider. Access to a payee database of all potential payees available for public viewing, and means to select payees as recipients of all or part of any income or other benefits generated by an affiliated communication may be provided. This may include profiles of each payee to aid a viewer in making selections. There may also be potential payees not viewable by the public.

Utilizing Modules and Affiliated Links

An ad agency or the system personnel may place ads for a client; clients may submit or design several different sizes or versions of an information module including the ad content. The ad content may include html, video, audio, flash, java, and other components, and may target different classes of addressees based on demographics, previous purchase, user preference, etc. User preference, as expressed in profiles, may extend to acceptable and unacceptable module formats, allowing them to select between text and HTML messages, putting size limits on them and the like, as well as content categories. Modules from the provider could be delivered to the system on a CD or through another medium as well as through the Internet.

An information module can contain or be itself an affiliated link, and may lead to a further destination. An affiliated link may be presented in text form, in disguised text form (not revealing the ultimate URL to which it points) and/or in more elaborate forms, which may include graphics, additional text, sound, and other attributes. The system may contain means for identifying the user of an affiliated link. A user may transmit or communicate an affiliated link or an ad module, or cause it to be transmitted or communicated, to an audience of one or more. When used, the link connects the recipient to the compounded marketing system and specifically to a category, a subcategory, or an item within a category or a subcategory. If the link is used, the system recognizes the sender of the affiliated link as the source and credits the sender with a reward if the recipient of the affiliated link took a particular action, which has been associated with a reward.

For example, if a sender wants to tell a recipient (or an audience of potential recipients) about a specific mountain bike, he can get an affiliated link related to that mountain bike from the system, which he can then send to the recipient in a variety of ways. It could be sent via e-mail, published online in a Web log (blog), included as a link in a web page, transmitted by an instant messaging system, printed in a magazine, and the like. This affiliated link identifies the sender so that he can be credited with a reward, and also connects the recipient to information about the mountain bike. If the recipient takes a rewardable action (e.g., places an order for the bike), the sender is credited with the reward.

In a further example, User A can get an affiliated link to a subcategory, which may be, for example, a specific manufacturer of mountain bikes or at a more inclusive level, of bicycles, or at a still more inclusive level, of recreational or sports or transportation products. If that affiliated link is provided to others and a User B uses it to connect to that subcategory, which may include any and all information the manufacturer wishes to provide, including one or more entire websites of any degree of complexity, and if User B takes any action within that subcategory that triggers a reward, User A may be credited with the reward. In other words, a reward may be offered for providing affiliated links connected to any level or aspect of the system, from specific items to subcategories at any level of inclusiveness, or to other aspects of the system such as services provided by the system (e.g., e-mail, shopping, and communication of various sorts of information) the reward contingent on specified actions being taken by a person to whom the affiliated link is provided.

Referring to FIG. 1, the compounded marketing application server 134 receives a request to submit the offering(s) from the provider client 112, processes the requests by categorizing the offering(s) or validating the provider's categorization and storing the provider offering(s) in the database 137 within the compounded marketing database server 136, and transmits one or more of the offerings to the user operating the user client 110 if the provider offering is within a category and module form and meets other criteria designated by the user as being acceptable for receipt of such offering via network 120. In one exemplary embodiment, the offering is transmitted to a predetermined number of the eligible users only. The transmission may also be delayed according to a predetermined criteria. For example, a user may designate that he/she wishes to limit the total number of offerings received or to limit the number of offerings received per time period (e.g., day, week or month, etc.), thus preventing the user from getting more communications than desired at one time. Other means of supplying provider offerings to the system may be provided as well, such as but not limited to on a portable physical medium such as a compact disc.

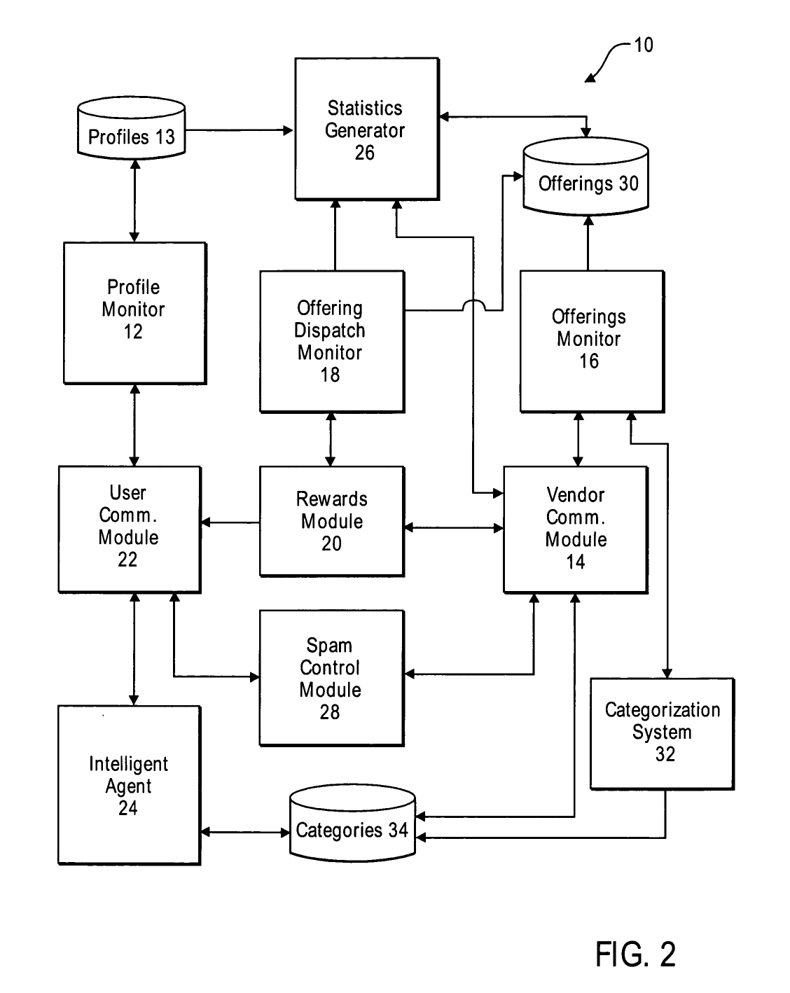

FIG. 2 is a block diagram illustrating a compounded marketing system 130 to facilitate computer-based commerce. In one embodiment, the compounded marketing system 130 may include a user profile monitor 12 to maintain a user profile in a profiles database 13 and, optionally, a provider communication module 14 to detect receipt of an offering (e.g., an advertisement) from a provider.

A user profile maintained by the user profile monitor 12 may include one or more user selections from a plurality of categories and/or other information related to that user such as contact information, user preferences as to frequency and type of contact (e.g., text, HTML, individual or digest, etc.), blocked senders, preferred senders and the like, and statistics of use and results of using the system such as, for example, responses to messages sent, earnings, distribution of earnings, current and past assignment of earnings, sources of earnings, earnings and other results of group efforts the user may be engaged in and the like, an address book or database and e-mail account associated with the user, and authorization or other information related to other facilities the user may have access to, such as a module creation facility, a publishing facility, and the like. User profiles may also include information supplied by the individual user as well as observed user behavior including, for example, but not limited to, personal characteristics such as but not limited to clothing sizes, geographic location and the like, preferences, including categories of interest, and methods of connection to the system of this invention.

In one exemplary embodiment, the provider communication module 14 may be configured to detect receipt of new vendor offerings, validate vendor offerings as acceptable according to system criteria as administered by the system manager, communicate information of interest to the vendor to said vendor including but not limited to sales statistics, system requirements, and the like.

Optionally, an offerings monitor 16 in communication with the provider communication module 14 may be created and used. Said offerings monitor 16 may be used, for example, to identify an offering as associated with an offering category, to store the offering in an offerings database 30, and to keep track of the offerings available for distribution to users. The offerings may be sorted by various characteristics, and have various pieces of information displayed with them, such as reviews from other users, popularity ranking, and the like. Each offering within a category may be available for purchase, subscription, reading, viewing, listening, or other appropriate actions. The offerings may be provided for a fee, which may be a cost in credits granted by the system, or free. Each offering may have one or more information modules associated with it. A user may be enabled to attach one or more information modules from one or more different offerings to an e-mail or other communication they wish to send through the system to their contacts. An information module may be combined with an identification of the sending user to allow tracking and crediting of activity and/or rewards. Offerings may include, for example, categorized or uncategorized offerings or presentations of goods, services, information, entertainment, invitations, and digital material. A user may also be invited to select the related category or categories to be included in said user's profile.

It will be noted that the compounded communication system 10 may be configured to conceal user contact information and user identity from the vendor. An offering dispatch monitor 18 may be utilized to detect a change to the user profile, identify the change if the user has selected or unblocked an additional category, identify a new interest offering in the offerings database associated with the additional open category in the user profile, and facilitate communicating the new interest offering to the user.

Optionally, a rewards module 20 may be created, which may be used to offer a reward to the user according to reward criteria defined by a provider, such as, for example, a sale to or a click-through by a second or successive user resulting from the first user propagating a vendor offering to the second user or, indirectly, to successive users. A reward may be in a form of a credit value, one or more points, one or more products or services, information, and a monetary value. The reward may be designated to the user or a third party, or divided as desired among multiple third parties.

The offering dispatch monitor 18 may be also utilized to prevent communicating desirable offers that are greater in number or frequency than indicated by the user.

The compounded marketing system 130 may also include a user communication module 22 to allow a user to actively invite offerings related to a particular area of interest (e.g., a category), and to provide access to a display of one or more such offers made available through the network without having to receive the information through e-mail, a content feed such as a Web content syndication format, instant messaging, and other means. The system may also include an intelligent agent 24 to identify items, offers, and categories. This information may be used to publish to the user one or more items of content identified as likely to be of interest to the user based on their actions in the system. It will be noted that “publishing” may include, for example, sending a vendor offering to user via e-mail, displaying an offer by electronic means, sending a categorized vendor offering to user via e-mail, sending invitations, and sending personalized offers. Such publishing may be effectuated utilizing a variety of means, such as, for example, printed or graphic media using physical delivery systems, sending individual or collected items on a CD, a DVD, or other media presently existing or still to be developed, personalized ads on TV, cable, satellite, radio, Internet and other means.

The system 10 may also include a categorization system 32 to categorize the offerings and/or to assist the provider in categorizing the offerings as they are received from providers via provider communication module 14. The categorization system 32 may be configured to operate in communication with a categories database 34 and the offerings monitor 16. The categorization system 32 may involve human inspection or determination of correct categorization.

A statistics generator 26 may be created to automatically generate a value or values associated with one or more user profiles. The statistics generator 26 may also be configured to collect information related to user profiles from the profiles database 13 and/or information related to the offerings from the offerings database 30. The statistics generator 26 may utilize such information to generate data related to the degree of interest in different categories (e.g., how many users are interested in a particular category). A spam control module 28, in communication with the user communication module 22 and the provider communication module 14, may also be incorporated in the compounded marketing system 130 to deter senders of unauthorized offerings. The spam control module 28 may be adapted to detect e-mails or other communications identified as inappropriate by the system 10, take action as defined by the system administrator, and receive and/or investigate spam complaints.

Inferential statistics may be useful in a variety of ways that improve understanding of the market by drawing inferences from various databases. The statistics generator 26 may collect and classify information in whatever form and format is desired by the system manager. Said statistics generator is preferably able to analyze information collected and generate reports in whatever form is desired by the system manger. Said statistics generator further preferably employs inferential statistics useful for selecting for users vendor offerings to same. Preferably said statistics generator further employs a quality-control module useful for managing the system. Preferably said statistics generator is capable of providing data and/or analyses to system management, users, vendors, and others in industry and government. The statistics generator preferably includes a variance alert sub-system. For example, a variance alert sub-system may track product returns, packaging, and missed deliveries associated with any vendor and other matters of interest. Said sub-system could enhance customer service by alerting management of a problem even before the vendor becomes aware, enabling faster response on the part of the system manager.

Although the profiles database 13, the offerings database 30, and the categories database 34 appear as separate databases, the compounded marketing system 130 may be configured such that these databases are part of the database 137.

Categorization

A categorization system 32 (e.g., a cataloging system utilized by the Library of Congress or an Internet directory that may be utilized by a search engine) may be used to categorize all offerings to a fine degree of discrimination, providing for selection by various criteria. Product criteria may be matched with a user profile. Without limiting selection to these examples, criteria available to be set by the user may include category of offering (e.g., goods, service, wanted, etc.), specific type of product or offering (a tool, an item of clothing, a vehicle, etc.), a price point or range including free, selection by source such as profit or nonprofit organization or payee(s), geographic proximity to a given location, brand name, or a unique identifier. Users may browse and/or search the database or databases of offers and products. This function may be performed by users, with or without automated (e.g., “wizard”) assistance, based on information and product supplied by a provider. This type of user search or browse may also be based on any other useful information.

053 The categories may be stored in the categories database 34. The categorization system 32 may be a hierarchical system that allows increasing inclusiveness at higher category levels, or increasing discrimination at lower/finer category levels. It may be extensible in a logical and consistent way as products and other offerings evolve and change. The user communication module 22 may be used to allow the user to select the categories representing the user's areas of interest and the user's consent to receive offerings that belong to the selected categories. The user profile monitor 12 may be utilized for database tracking of personal preferences as provided by users, where personal and interest profiles facilitate appropriate contacts and protect against unwanted contacts. The user profile may be stored in the profiles database, and may include any information related to the user which helps the system function.

Interest Profiles

A profile (also called an interest profile or user profile) is comprised of information which may include but is not limited to: user name and/or other contact information; categories of stated interest; categories of possible but no indicated interest; categories indicated as being of no interest; user product preferences and requirements such as color, form, size, texture, performance characteristics and the like. The user has access to the profile and may change preferences at any time to update changes in their interests or other profile information. An interest profile may also be utilized to store the user's identification information, which the system can use to allow or deny the user access to other features of the system, such as community pages (e.g., pages or sites associated with the system, which support interactions among members sharing one or more interests), e-mail service, and one or more database address books. A profile may be established by any user who has an e-mail address.

The creation of interest profiles need not be dependent on having an e-mail account with the compounded communication system 10. An interest profile may facilitate blocking affiliated communications of predetermined characteristics. This may be termed as a negative part of an interest profile. A positive part of an interest profile is that a user can highlight in various ways the areas of specific interest, which may be accomplished by a variety of means. For example, a user may put him- or herself on a seed list for a topic, or choose to receive an affiliated communication from a particular sender whose selection of offerings and/or accompanying personal writing or other inclusions are of interest to the user. An interest profile may also indicate that the user is eligible for earning income from any commissions that might result from propagating offerings, or an indication that the user is a subscriber to a publication produced by a publisher who addresses the user's interests. The collection of user profiles (e.g., a profiles database 13) may be centrally maintained while providing distributed functionality.

Maintaining the Profiles

In one exemplary embodiment, interest profiles maintenance may be centralized, as described above with reference to FIG. 2. In another embodiment, an interest profile may be maintained by the user's Internet service provider (ISP). The user can select and deselect categories at any time, providing complete control over what he/she receives. In addition, the user can set a limit on the total number of communications he/she receives on the associated topic, or daily/weekly/etc. limits until the user cancels the topic. In a further exemplary embodiment of the present invention, there may be a centralized system to facilitate and maintain multiple profiles of the same person at multiple ISPs, or on multiple computers within a peer-to-peer arrangement, or at the individual's ISP, which is providing their e-mail service, or at their e-mail service provider if not their ISP.

Utilization of the Profiles

In one exemplary embodiment, a user profile may be utilized to block unwanted email by forcing all email to be filtered through their preferences in their profile. For example, the user may choose not to accept any email not properly categorized by the system described in the present disclosure. The result may be a self-enclosed spam-free email community. Email may originate within the system or be properly categorized in accordance with its rules, and be delivered to system participants, so categorization and filtering would be built into the entire transmission, from sender to receiver. Violators could be expelled or blocked. The user could issue “safe passage” codes to individual senders who could use it to email anything to that particular user. All others could be checked for acceptable categorization before being forwarded, which may be described as a gated community for email.

In one embodiment of the present invention, an organization could collect or refer the collection of profiles, then profit from their rental or use them directly. An organization with this kind of an arrangement with the compounded marketing system may be termed a “managing organization” (MO). Magazine publishing companies are one example of such an organization. If a central facility handles sales and other distributions of, for example, free bonuses, information products, etc., the magazine company could make an attractive offer to its readers, such as a CD or free report, or discount coupon book from their advertisers, so readers may have an incentive to create profiles in order to receive the attractive offering. Radio and television stations, cable networks, and so on could all do likewise, as could websites and other communications media. Organizations could refer their members, schools could suggest parents and others sign up to support the school, and so on.

An MO may be an entity providing or referring new users to the system in return for specific benefits. In one embodiment, the profiles may be generated at an MO and then communicated to a central location. Individuals interested in creating a profile may be referred by an MO to the centralized hub of the present system, where a profile could be created. Such central location may be independent of an MO. For example, the profiles may be generated through the activity of an MO, which may be any organization permitted by the system to solicit for more users or to publicize the system, and which may then earn a percentage of all monies paid for the use of the profile information of those referred by them from that time forward, or for a certain period of time, or another reward system may be provided. Each profile may be marked with the originating MO's code or otherwise identified as originating from that source.

059 Access to profiles could be free or at a reduced cost for the MO responsible for referring the person who created the profile and at a higher cost for others, at least part of which may be profit to the originating MO. This mechanism provides an incentive for MOs to gather initial profiles, and will encourage them to spread the system as fast and as far as they can. Profiles may become long-term sources of income in this way.

In one exemplary embodiment of the present invention, the statistics generator 26 may facilitate regular (e.g., daily) compilations of how many user profiles in the profiles database 13 have a specific category selected. This may be accomplished by a simple run of a counting program if the profiles are stored in a centralized manner, or by automatically collecting information from various ISPs and then formatting the data into an appropriate format, if the profiles are stored at the user's ISP in a decentralized way.

One advantage of centralized storage is that the participation of local ISPs is not required, and centralized storage addresses problems that typically occur when a subscriber to an ISP discontinues a relationship with the company. The centralized storage avoids having to have the relevant profile moved, canceled and recreated, or having a copy kept in the user's e-mail program so it can be uploaded. The central warehouse proposed above seeks to addresses these issues. Consider further that, in this way, MOs can continue to generate revenue even from subscribers who cease to use them as an ISP, if that was the relationship, and if they fail to participate they are essentially giving the opportunity for income to some other MO, which may refer the person to the system.

A central facility may also manage the selling process to individuals. Specifically, a central facility may update the profiles, collect and disburse funds from sales, communicate with whichever entity needs to know to fulfill the order, and so on. Information on recent sales would make certain profiles even more valuable, increasing their income production, as recent purchase of a related item is one of the desirable characteristics of a mailing list.

A vendor may have an ongoing arrangement with an MO or the central facility to send an ad to everyone who opens up certain categories in their profiles. This could easily be the whole marketing program for a product, set up once and active for as long as the vendor desires.

As this could be a common tactic, and as people might limit the number of ads to which they are open, and as being first is often desirable, the vendor might have to bid for top spots in this “instant delivery” system. This may encourage providers bidding against each other for a limited number of openings.

In one exemplary embodiment, the compounded marketing system 130 may utilize features that allow a provider to bid for a top spot. It may also factor in the user interest, as shown by response from users of the compounded marketing system to the ads of various vendors, putting more interesting ads near the top. The compounded marketing system 130 may utilize a page of highly popular products, or products calculated to be of interest to the viewer, shown whenever a user forwards an ad or at other times as determined by the system administrator. The intelligent agent 24 may facilitate gathering and compiling information to determine the degree of interest in a particular product at a particular display location within the system.

In some cases, the top spots could be rotated or spread out to allow more products a chance. For instance, the first X,000 exposures could be at one rate, with an increasingly steep surcharge for each additional X,000. This lets interested providers pay the premium if they so desire, while keeping the system open to other providers not interested in doing so.

Profile Updates

As interests change, users may update their profiles and no longer receive information about certain products/services. For example, if a user is interested in telescopes but moves to a location where star gazing is difficult, the user need only change her or his profile and all senders who had the user initially indicated as being interested in telescopes might no longer see the user's name associated with that topic (if the user chose to make that information public). Whether or not it is made public, the change in the user's profile would automatically and instantly block affiliated communications about telescopes. Thus there may be two sets of profiles. The recipient makes one, which controls what the recipient receives. Each sender may also make a profile of each of their contacts, including interests, feedback, and previous responses, if they choose to do so and to the degree the system allows. The recipient and sender profiles do not have to match. There can be inaccuracy on the sender's part, because the hub protects all recipients in accord with their wishes.

Profiles Provide Opted-in Seed Lists

The e-mail service might be free but relatively basic for someone who has not provided a profile of their preferences, but in return for providing a profile a person may receive a higher level of service, such as protection from duplicates, ability to block categories of affiliated communication, participation in the profits of forwarding communications and other advanced services. These profiles are one source of the seed lists. Users can choose to be on particular seed lists of particular interest to them. The use of seed lists is something the operator of the system could sell, though the provider would preferably never see the contact information. The seed lists may function as the original lists a provider's message is sent to, to initiate the chain reaction of affiliates forwarding the message to others.

Advantages to a user of being on a seed list are:
1. One is in the first group to hear of a new offering, which may have value for a variety of reasons.
2. Being on the seed list puts one in the best position to pass on a message to earn referral fees.
3. One will see everything passing through the system in the categories one has chosen. This is valuable for professionals, reviewers, merchants, competitors, enthusiasts, fanatics, fans, and others who have a need for complete information.

Having received an affiliated communication or notice of the possibility of receiving such a communication and having chosen to receive it, but not being an affiliate, a person interested in a product can learn about the product. They can also become an affiliate and send an affiliated communication via the system, to friends, relatives, and colleagues who might appreciate learning about it. By sending the affiliated communication to their connections they inform the recipients of products and services of potential interest, they may save the recipient some money over a straight retail purchase through a person-to-person discount (not essential to the present system, but a possible sales inducement), and they make some money for themselves and/or for some person(s) or group(s) they care about.

Altogether this is a powerful set of incentives to join and participate. Even more powerful, in the full system, an individual could assign the money or other benefits he/she would earn to one or more third parties, which could be one or more of a charity or other cause, or any individual, including the recipient of the communication as a second layer of benefit to him/her. The people who get affiliated communications can do the same in turn, providing benefits to the individuals or organizations of their choice.

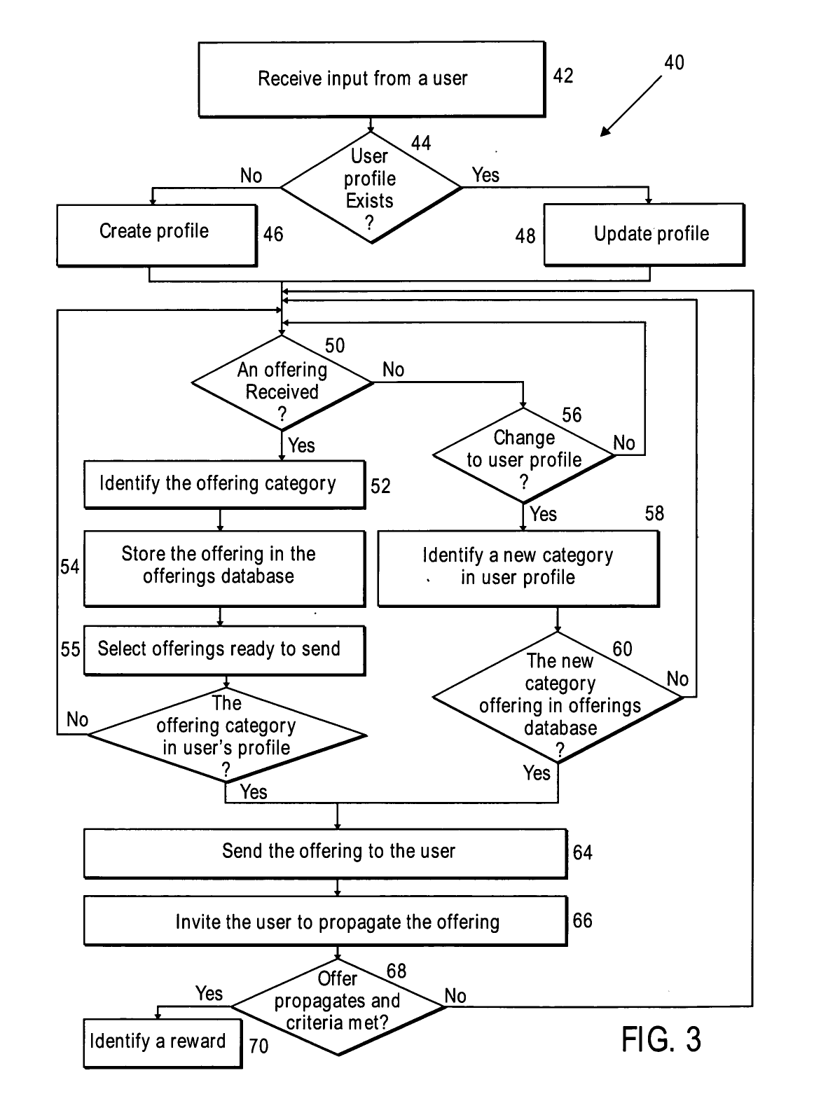

FIG. 3 is a flow chart illustrating a method 40 to facilitate computer-based commerce utilizing affiliated communications, according to one exemplary embodiment of the present invention. The compounded marketing system 130 receives input (e.g., a category selection) from a user at operation 42. A new user may contact the system in other ways as well. For example, by responding to a sales offer, by responding to a solicitation to join, by choosing to block any or all categories, by making a spam complaint, by requesting a free product as an incentive, by pure curiosity, etc. If the user profile exists at operation 44, the user profile is updated with the selected category or other information at operation 48; otherwise the user profile is created and stored in the profiles database at operation 46. When an approved offering is received from a provider at operation 50, the offering is assigned a category at operation 52 and stored in the offerings database at operation 54. At operation 55 the offerings that are ready to be sent are selected. If it is determined at operation 62 that the offering category appears in the user profile, and if all other delivery criteria are met, the offering is sent to the user at operation 64.

The profile monitor 12 monitors the profiles database to determine, among other things, if a new category is opened or added in the user profile. The offering dispatch monitor 18 identifies a new category in the user profile at operation 58. The offering dispatch monitor may determine at operation 60 that the offerings database 30 includes an offering associated with the new category, which the delivery criteria will allow to be sent to the user. Said offering is sent to the user at operation 68, as controlled by the user's profile in regard to frequency, number, size, and other characteristics.

When the offering is sent to the user at operation 68, the user is invited to send the offering to other people at operation 66, if the user believes that the offering is of interest to them. If the user forwards the offering at operation 68, the user may be entitled to a reward at operation 70 if, for example, the forwarded offering resulted in a sale. Rewards may be granted to the user for a wide range of responses to an offer, at the choice of the provider. Responses may include but are not limited to, purchases, subscriptions, requested information, downloads, samples, feedback, evaluations or appraisals, reviews, event reports, bug reports, testing data, technical matters, receiving job applications, offers of employment or other interaction (consulting, other services, etc.), focus group participation, suggestions for improvement, entry in a contest, and playing a game.

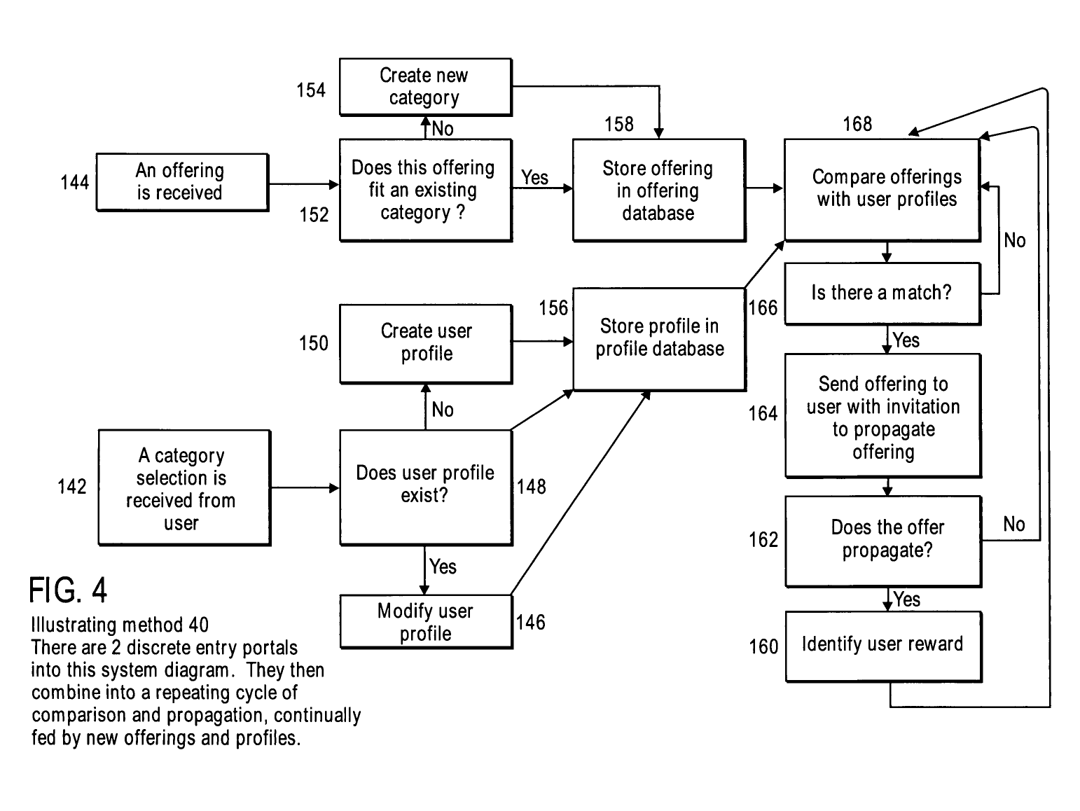

FIG. 4 is a flow chart illustrating a method 40 to facilitate computer-based commerce utilizing affiliated communications, according to one exemplary embodiment of the present invention. There may be two distinct entry portals into the system, which combine into a repeating cycle of comparison and propagation, continually fed by new offerings and profiles. The compounded marketing system 130 receives a category selection from a user at operation 142. If the user profile exists at operation 148, the user profile is updated with the selected category at operation 148; otherwise the user profile is created at operation 150 and stored in the profiles database at operation 156.

When an offering is received from a provider at operation 144, the offering is assigned a category at operation 152 and stored in the offerings database at operation 158. If the offering does not correspond to any of the existing categories, a new category is created at operation 154. If it is determined at operations 166 and 168, that the offering category appears in the user profile, and if all other delivery criteria are met, the offering is sent to the user at operation 164.

When the offering is sent to the user at operation 164, the user may be invited to send the offering to other people, if the user believes that the offering is of interest to them. If the user forwards the offering at operation 162, the user may be entitled to a reward if a desired action results. The reward is identified at operation 160 if, for example, the forwarded offering resulted in a sale.

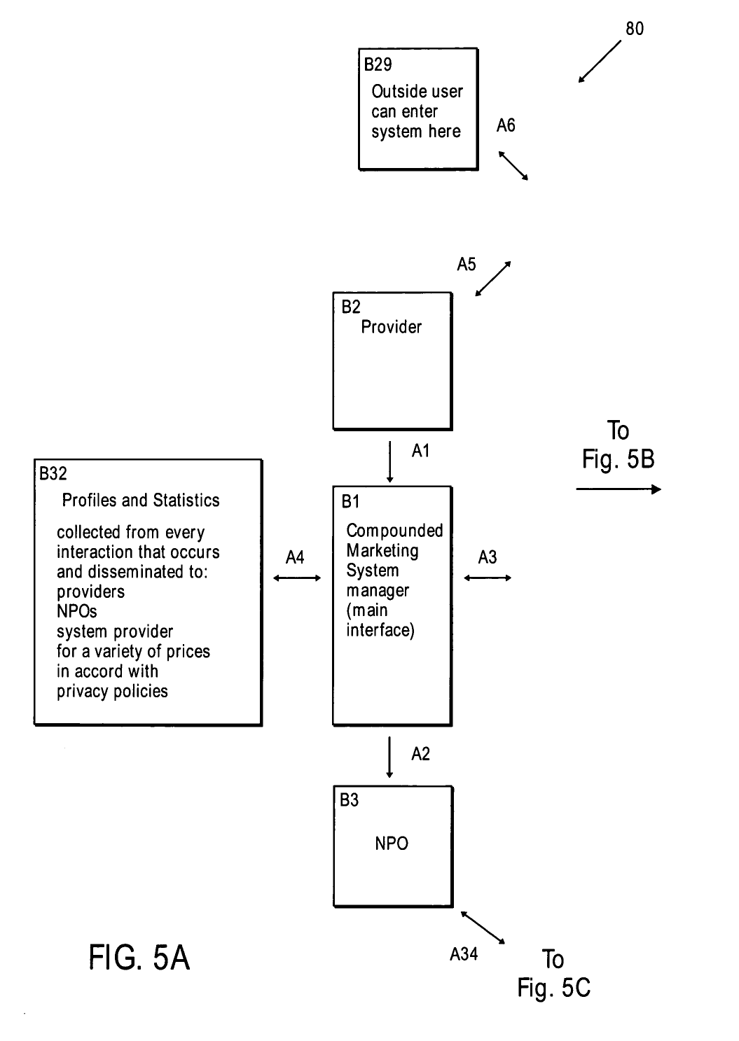

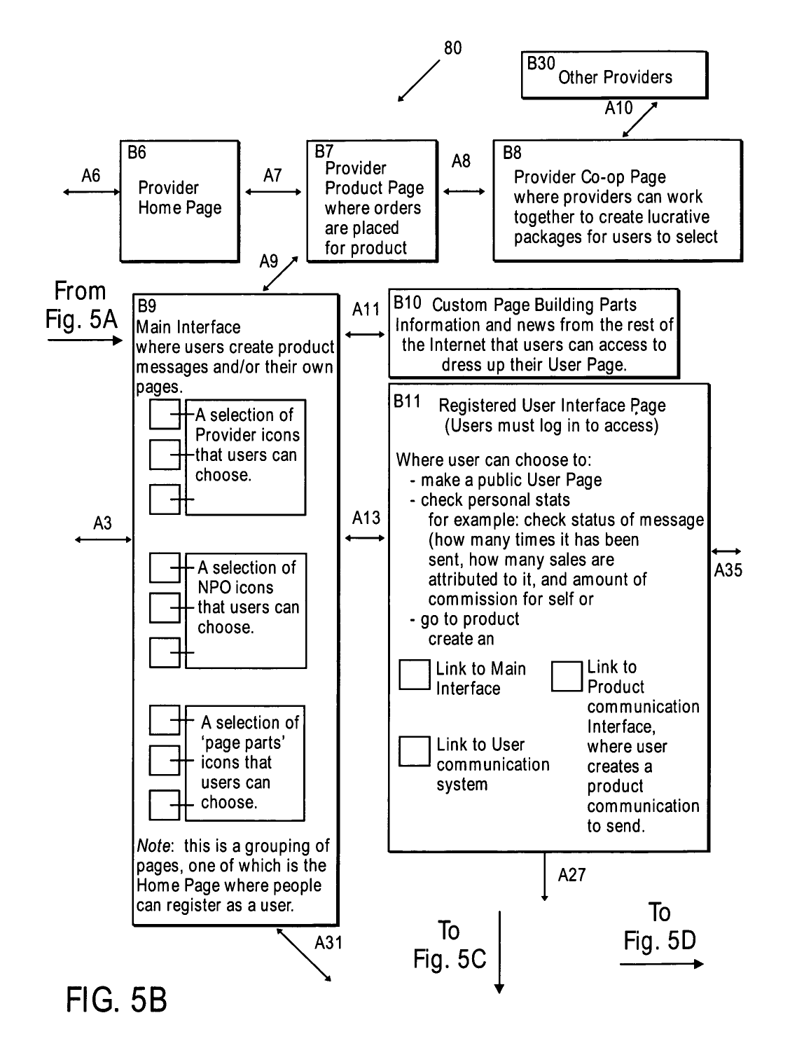

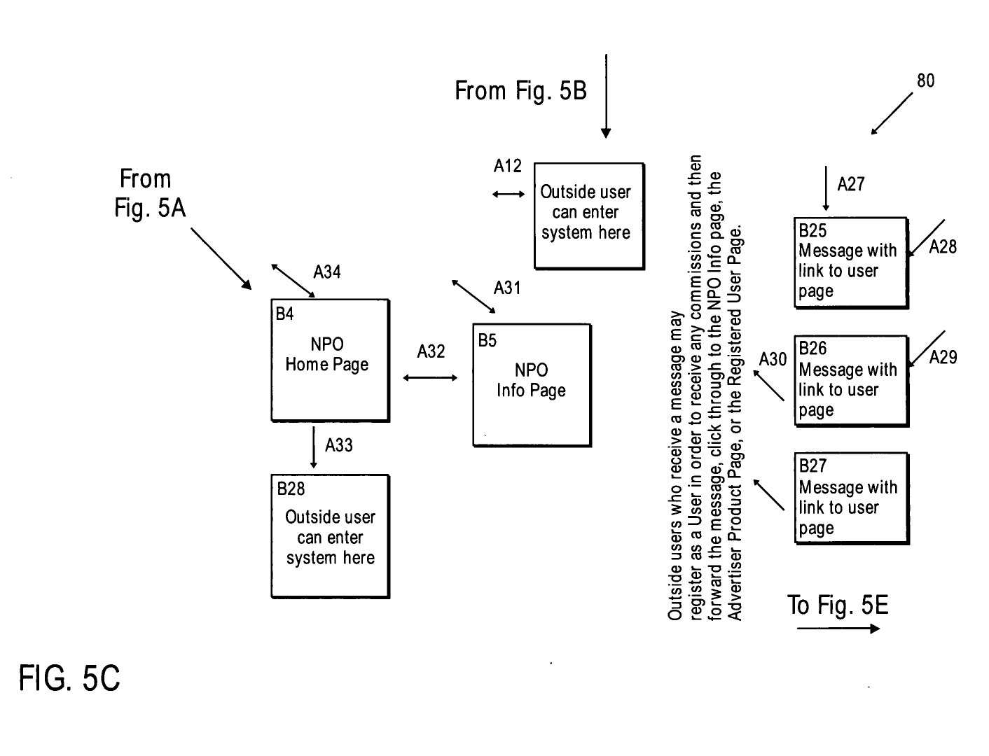

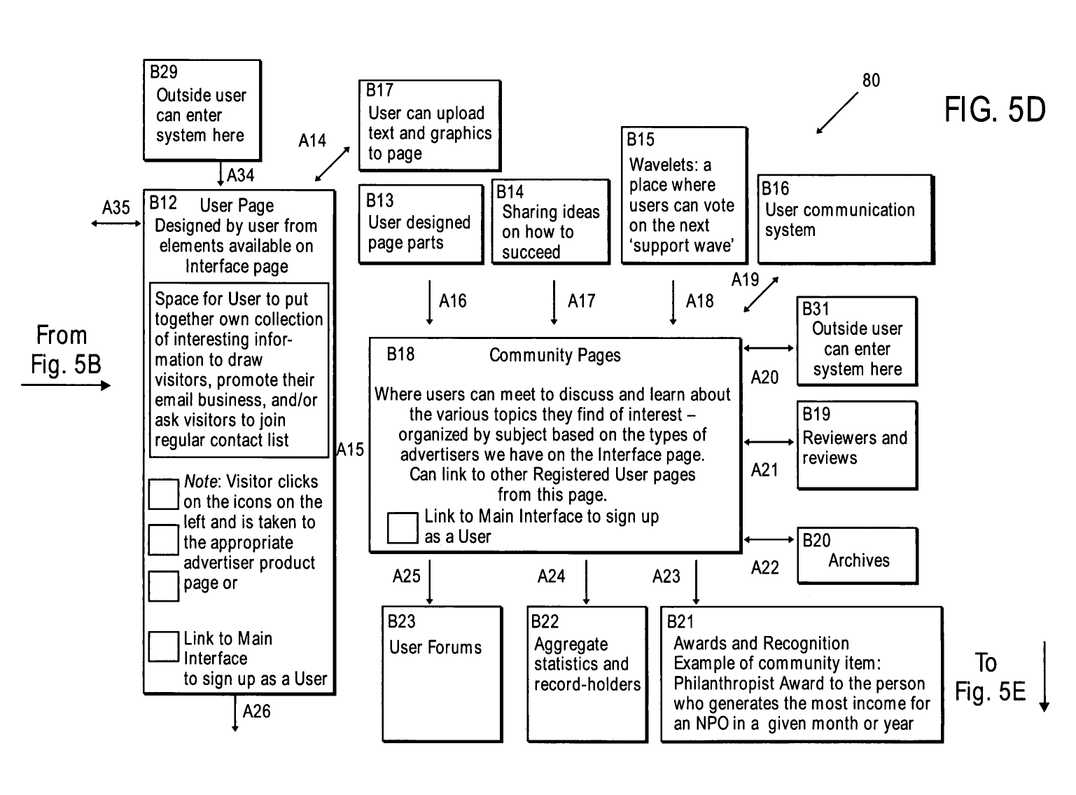

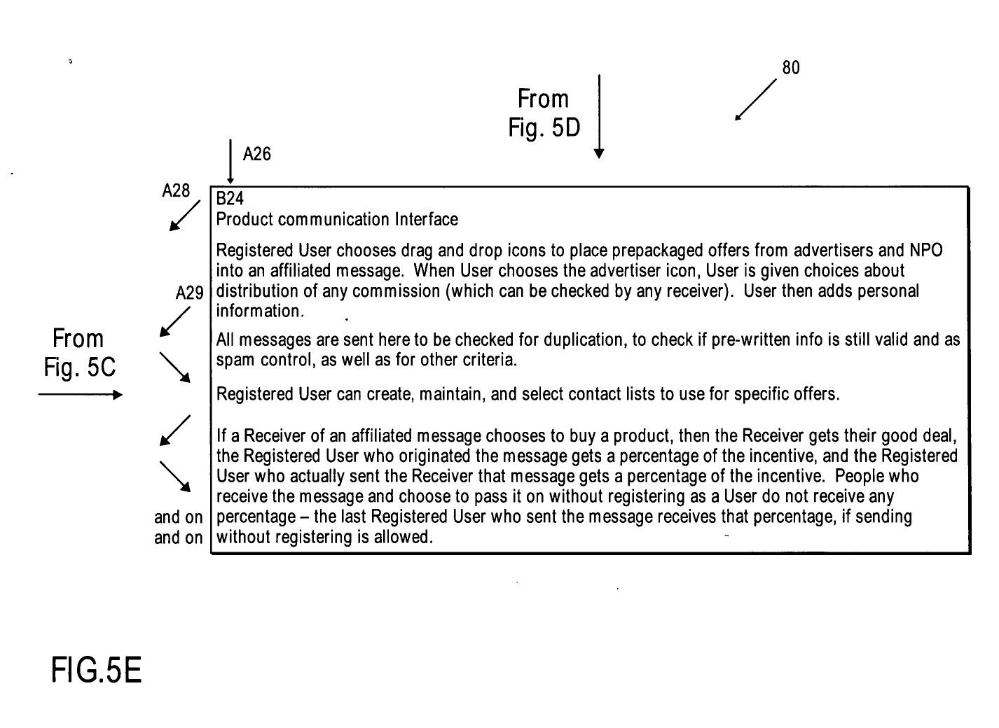

FIGS. 5A-5E illustrate a block diagram illustrating components to facilitate interaction between different participants in a compounded marketing system 80, according to one exemplary embodiment of the present invention. Block B1 is a compounded marketing system manager. In one embodiment, the compounded marketing system manager B1 may perform the functions of a central coordination hub. Block B2 is a provider. Block B3 is a charity. Block B4 is a charity home page. Block B5 is a charity information page. Block B6 is a provider home page. Block B7 is a provider product page where orders are placed for a product. Block B8 is a provider cooperative page where providers can work together to create attractive packages for users to select among for forwarding to their contacts. Block B9 is a main compounded marketing system interface where users create product communications and/or their own web pages. The main compounded marketing system interface B9 may include a selection of provider icons or another means users can use to construct an offering or a web page. The selection of provider icons may include a selection of charity and other icons, allowing some or all of the proceeds of the purchase to be diverted to the party chosen, and a selection of ‘page parts’ icons facilitating web page construction. In one exemplary embodiment, this is a grouping of pages, one of which may be the compounded marketing system manager home page where people can register as users.

Vendors (e.g., companies actually selling the product) can enter the central coordination hub in a variety of ways. They can insert single offerings into the communications distribution system or compile their offerings into Internet publications, or create websites that collect particular selections of offerings from only themselves. Vendors can build web pages for specific products, for a line of products, or as an extension of their independent web catalog. Others can take the role of aggregators and resellers, collecting related offerings into Internet publications or websites.

Affiliated Communications and their Relationship to the Central Coordination Hub

The compounded marketing system 130 does not necessarily require a website or an e-mail newsletter but is something anyone with e-mail could use, passing messages directly to specific people known to the sender who are likely prospects for the offering. These sales or other messages are to be sent to people already known and with whom there is a relationship. A personal e-mail (or some other form of communication) about a product from a known acquaintance or friend is also a powerful recommendation, more likely to be read receptively than a message through other media. Other factors such as celebrity or expert status of the communicator come into play as well, and can be incorporated.

Affiliated communications according to the present invention may have a personal section written by the sender and it may also have a part the sender cannot affect: the provider offering, which is included anew in refreshed, current form each time a communication is sent to a new person through the hub. The provider offering can include a sales message, a link to a site with the sales message, or a link to the transaction site, or other information and links as desired. Because this communication is managed through the central coordination hub, provider messages can be modified within the communication every time it is sent through the hub. This allows for completely up-to-the-second updated information to be transmitted from seller to buyer, and even for personalization to the recipient. Because the sales message is renewed each time from the hub it works for limited time offerings, or for publications in which the content may have been or be continually or regularly updated, and would stop propagating whenever the hub was instructed to stop sending that particular message.

A person receiving an affiliated communication promoting a product they like, and wanting to forward it to a friend, could write a personal message to that person. When they send the communication, it first goes to the hub. The hub records who sent the communication and to whom it was sent so the sender get sales credit if a sale results or if another desired action is taken by the receiver, checks to make sure the receiver's profile allows for provider messages of this type to be received, checks to make sure the receiver has not received their limit on copies of the same offering (in accordance with settings they have made on how many to receive, and from whom), checks to make sure the receiver has not blocked communication from this sender, adds or modifies the provider offering as currently instructed, performs any other checks as currently specified by the profile or the system administrator, and then sends the communication to the receiver if it is acceptable after all such verification. In fact, the hub could track who has received a specific offering and send revisions or follow up offerings, if the originator desired and if the recipient opted for it (such as with air fares to a favorite destination, new music from a favorite group, books from an author or publisher, etc.; in this way it becomes a way to follow interests closely and get special offers, such as prepublication prices). Instructions for sending an affiliated communication on to more people, as well as information about how to join the system as an affiliate, may be included in affiliated communications, so that every message sent can potentially grow the system. Participants could be offered credit for every new affiliate who joins as a result of a communication they send out. These functions are described as examples and not as an exclusive list.

The process can repeat until a large number of e-mail-connected individuals and companies potentially interested in a specific product or group of products have been contacted with an offer, each of them one time only or as limited at their choice through profile settings, and most likely from someone who knows them personally.

Returning to FIGS. 5A-5E, block B10 is a page where a user may access building components to create a custom page. Information and news from the rest of the Internet can be accessed by users via main compounded marketing system interface B9 to dress up their user page. Block B11 is a registered user interface page (users must log on to access), where a user can choose to make a public user page, or check personal statistics (e.g., how many times an offering has been forwarded, how many sales are attributed to it, and amount of commission earned for self or others). At the registered user interface page B11, a user may also access a product communication interface to create a communication with offerings, an affiliated communication. Links to main compounded marketing system interface B9, to user communication system B16 (e.g., a user e-mail system), and to product interface B24 (where user may create a product communication to send) are provided at the registered user interface page B11. Block B12 is a user page designed by user from elements available on interface page. The user page B12 may include space for a user to put together the user's own collection of interesting information to draw visitors, promote their e-mail business, and/or ask visitors to join an e-mail list. Visitors may click on the icons within user page B12 and may access an appropriate advertiser product page or charity page. The user page B12 may include a link to main compounded marketing system interface B9 to sign up as a user.

Block B13 is a user designed “page parts” page. Block B14 is a module to allow sharing of ideas. Block B15 a place where users can vote on the next ‘support wave’. Block B16 is a user e-mail system. At block B17 users can upload text and graphics to user page B12. Block B18 is a collection of community pages where users can meet to discuss and learn about the various topics they find of interest. All people sharing an interest who may have personal, organizational or other connections, and who may thus pass along relevant information to each other make up a community of interest. A community of interest may be enabled to interact through community websites or web pages such as community pages B18.

The topics may be organized by subject matter based on the types of advertisers that appear on the main compounded marketing system interface page B9. Community pages B18 may allow a user to link to the other registered users pages B11 from this page. Community pages B18 may include a link to main compounded marketing system interface B9 to allow a user to sign up for a compounded marketing service. Block B19 is an interface for reviewers and reviews. Block B20 is an archive. Block B21 is an awards and recognition module. The awards and recognition module may facilitate a community item, such as a philanthropist award to a person who generates the most income for a charity in a given month or year. Block B22 is to facilitate access to aggregate statistics and record-holders. Block B23 is a user forum to facilitate discussions among the users.

Block B24 is a product e-mail interface. A registered user may drag and drop icons to place prepackaged offerings from advertisers and charity information in the e-mail. When a user chooses the advertiser icon, the user is given choices regarding distributions of any rewards (e.g., commissions), which may optionally be made available for inspection by any recipient of the offer to verify that funds will indeed go to a named charity, for instance. Users may add personal information to the e-mail. All e-mail is sent to the product e-mail interface B24 to be checked for duplication, to check if the offer is still valid, to check the acceptability criteria set by the addressee, and as spam control before being sent to the addressee. Registered users can create, maintain and select personal mailing lists to use for specific e-mail offerings via the product e-mail interface B24. People who receive an e-mail and choose to pass it on without registering as a user do not receive any percentage and to discourage this practice only e-mails originating from the system and sent directly to a user may qualify for reward. However, an unregistered user who receives an e-mail may register as a user with the compounded marketing system 80 prior to forwarding the e-mail, which may allow the user to receive a commission, as well as click through to the charity information page B5, the provider product page B7, or the registered users page B11.

Blocks B25, B26, and B27 are e-mail pages with links to the user page B12. Block B26 is e-mail with link to user page. An outside user can enter the compounded marketing system 80 via modules illustrated by blocks B28, B29, and B31. An outside provider can enter the compounded marketing system 80 via a module illustrated by block B30. Block B32 is a profiles and statistics module to facilitate collecting profiles and statistics from every transaction. This information may be used to provide reports and analyses to the system manager and outside parties.

Other Features of the Compounded Marketing System

Some exemplary functions of the compounded marketing system 130 may include an access to a more limited and personal list of payees preferred by the affiliate, means to add or delete payees from this list, as well as means to combine personal messages and offering modules into an affiliated communication, and send it to selected individuals from a sender's database of recipients, or to others not in the database, and to direct benefits to payees as desired. A wizard or other automatic assistance may be available to help an affiliate to accomplish all necessary steps and to check that all have been accomplished before sending an affiliated communication.

Creating an Affiliated Communication

Convenient means to create affiliated communications may be a useful feature provided by the system. For example, providers may be enabled to upload or create drag and drop icons of offerings that affiliates can then insert into their e-mails. These icons could contain modules including links back to provider product pages B7 and B8, where recipients of the e-mail can peruse the sales message and purchase items.

Affiliates may create e-mails or other messages using their own information and the offering icons or other means provided to create such messages. Profiles created by recipients prevent unwanted communications from being delivered. Profiles of their contacts that users create allow them to target specific groups with information and product offerings they think will be of interest. Affiliates can create, maintain, and select their own mailing lists from their own personal databases of contacts (an advance over “address books”) to use for specific e-mail offerings.

An affiliated communication may be forwarded by a person who is not an affiliate. In this case the commission on a sale is earned by the first affiliate “upstream.” The lack of commission to the sender may discourage such forwarding outside the system. Commission may also be denied to any party named as a beneficiary in an offer forwarded in this way. Further, computers to which a specific offer has not been sent through the system may be denied access to information about the product through the links in the affiliated communication, making it useless to the recipient. That is, when a recipient clicks a link in the e-mail, their machine may be identified as not one which has been sent an authorized affiliated communication, and instead of being shown a product page with more information, for instance, they can be shown a page explaining the situation and giving them options to report the sender, among others. There may be, however, an active link in each affiliated communication allowing recipients to report the person sending the e-mail outside the system so the system administrator can inform the sender of the policy about how to send affiliated communications, or take other action to protect the public from unwanted communication such as barring them from access to the system or blocking all e-mails to them from the system, so they will have nothing to forward, if they persist.

The flow of forwarding, affiliation and purchases is tracked carefully by the central coordination hub so that affiliates can be paid and so that the service gets its share of any per sale or per contact or other arrangement. The interest profiles contain potentially highly sensitive information and are highly proprietary and protected.

Features: Transparent Arrangements

The terms of each affiliate arrangement including the immediate and ultimate sources of the message may be clearly stated in the affiliated communication or other message, either in the body of the message or available through an included link.

Associated with the link just discussed or through a separate link the sender and/or originator may provide more information about themselves, including who they assign earnings to, and what their background in that area is. This link might also take a user to the personal or organizational web page the sender may have created on the system, which in turn may detail their interests and the products they have affiliated themselves with. Following these links could be a very effective way for users to find compatible organizations and people, discovering more about people one knows already, and finding communities of interest.

Each individual may have their personal records available online to them, showing what they sold, how much was earned, and who was credited with how much. For charity projects it can show the results several generations deep, showing the cumulative effects of their participation, to encourage them to continue.

Features: One Copy per Recipient

The compounded marketing system 80 may be configured to prevent anyone who is registered from receiving more than one copy of a particular affiliated communication if that setting were chosen, avoiding another potential annoyance. Avoiding getting more than one copy and avoiding affiliated communications of no interest would be a good reason for many people to register and create profiles limiting or blocking affiliated communication from the system. That is, if affiliated communication to unregistered communication addresses were allowed by the system. This “user controlled,” “target controlled,” “audience-controlled,” or “recipient-controlled” approach gives control over the product or service information one is exposed to the person potentially receiving e-mail or other messages from the system, reversing the model of “interruption-based” advertising, wherein desired content is accompanied by advertising which may or may not be welcome. On the contrary, users of this system can pick and choose exactly which products, services and other information they will receive, and eliminate all else. This approach ensures for recipients and senders alike that every contact is at least passively, if not actively, welcome.

Features: Prompt Forwarding

Knowing recipients are protected from receiving messages they do not want, some people at least would be very prompt in forwarding affiliated communications to their contacts if the income mattered to them, or if they just like being first. This tendency will help speed messages through the system.

Pattern establishment will also help. This can be facilitated, for example and not by way of limitation, by setting up a contact management system allowing the user to assign any one person or other contact they know to any number of interest categories for easy mass forwarding of relevant e-mails. The system could allow personalization of e-mails as well, automatically inserting names and other relevant details from the database as instructed by the user.

As growing numbers of people learn to forward affiliated communications and adopt the practice, as they settle on who they forward them to and as they assemble their lists of contacts in their contact database, more and more of the possible universe of contacts will be incorporated into the messaging network.

The system may provide for automated forwarding. For instance, a user may want to be informed of every new offering from a specific musician. This user may elect to be on the seed list for that musician or may choose to receive notification of such new offers automatically from someone elsewhere in the information distribution chain, such as a reviewer, who may themselves be on the seed list for the musician or on a special pre-release seed list as a reviewer. Similarly a user may elect to automatically receive particular kinds of affiliated communications from a particular source, such as a person or organization they wish to support with referral fees from their purchases or other activities. With automated forwarding any other levels of affiliation are tracked and credited appropriately by the system, yet the recipient receives it as rapidly as anyone else because all human delay can be taken out of the transmission process. In this way earnings and relationships are maintained, while communication takes place as rapidly as possible for those interested, wherever they may be in the network of connections.

With data-based forwarding in terms of interest-based contact groups and with automated forwarding from trusted sources, a new and attractive product falling into this system can theoretically be exposed to its entire online market in a matter of days if not hours or minutes, once that network of connections has been created.

Features: Full and Filtered Contact

One option would be to sign up directly to receive everything in one or more product areas. One would do this if they were either very interested about something, or if they were studying a market sector, or if they were a retailer in that field, or if they wanted to act as a filter, picking the best and passing that on, intending to make an income from sales based on their discrimination and taste, and for other reasons.

Followers of a particular interest could send out e-mails and other messages containing affiliated links and modules along with other information, such as reviews and commentary. Those who do this regularly would be publishers, in our definition. Publisher ratings from readers could be posted so new people looking for a guide in a particular field could find the best, or at least the most popular. The top-rated publishers could become very influential in their spheres and could make very good incomes. They might receive review samples of the kind of material they work with. It could be mountaineering equipment, or fly fishing gear, or a genre of books or music.

Someone who wanted guidance to the best of a particular field filtered by someone with similar or better taste, could search the user evaluations of the experts in their interest area, read samples of publications posted online, find one compatible with their interests, and subscribe.

Features: Authentication

Another feature of the present invention is authentication of the sender, and source attribution. That is, the originator of a message is a registered user or vendor known to the system and their identity may be made visible to recipients upon inquiry or automatically at the recipient's choice as expressed in their profile. If false or misleading information is published through the system the ability to assign responsibility and to kill affiliated communications at any time, and to stop their spread through the Internet, at least as originating from the system, would be desirable.

Features: Custom Compilations

An affiliated communication compiler comprised of any useful facilities such as templates may allow a user to create their own custom affiliated communication compilation or compilations by clicking on or otherwise manipulating ad and information modules they want included. There may be several modules of different sizes and degrees of thoroughness and in a variety of presentations for a single product, including, for example, animation or a simple link with or without descriptive text or illustration(s) to suit the needs of the person assembling their custom affiliated communication or publication. The whole compilation can be made into a unit unalterable by recipients or forwarders, except to add a personal note, their own name, their affiliation code, and the like. For instance, a compilation of modules may be converted into Portable Document Format (PDF) and could be made available to registered system users.

A person creating such a compilation is a “publisher” as defined herein, and may be permitted to earn a percentage of all sales or other desired responses resulting from use of affiliate links in the publication, no matter how many times it is forwarded, as a reward for their initiative. Users who pass the compilation on as an affiliate may also be eligible to earn a portion of the commissions in the usual affiliate way, earning on desired responses from those to whom it is forwarded and optionally earning from desired responses from some number of succeeding levels of transmission as well.

With modules created for each product, and templates for the affiliated communication compiler, a person or group could create their own collection of products (along with optional editorial and other material of interest) by selecting from lists of products. An individual with good taste or other qualifications may do this or a nonprofit group may offer either a selective choice of products related to their group or mission, or any selection of things their members would be likely to buy in any case. This ability allows them to divert some or all of the commission money earned to the group. Any organization, even if for profit, may be allowed to use this process.

Celebrities: Imagine golfers having a professional player tell them about a new and outstanding golf club. Using the seed list concept, the player can write his affiliated communication or other message (or have someone do it for him), send it to an appropriate list and let it spread with no further effort. This is the relationship of “celebrity sponsor,” and it can be written in the third person, with quotes, or as a direct pitch if the celebrity really wants to put his/her personal stamp on it. The system can be set up to provide a reward to the celebrity sponsor or any other person or entity for every desired action. Each person responsible for connecting the offer or offers to someone who responds as desired may receive a referral fee as well.

This channel can also be much more extensive and personal than other media, with links to websites devoted to filling out the experience of the affiliated communication, such as updates, chat rooms with other members or people considering the purchase, where one can talk or listen in on live chats with the expert or celebrity, and the like.

When the networks of connection are fully evolved and automated the ability of a group to spread the word about something would be huge, making this the preferred medium for promoting events and other time sensitive information.

Another use of this system is to provide free notification to users of events in their locale, or in the locale or locales of their choice. Event sponsors may be allowed to list their events at no charge, including making modules as previously described (which may be similar to flyers or posters, for example), and optionally including all the detailed information desired. Information on events may be available for browsing from the database, or reachable through links in announcement e-mails.

Free listings are an advantage to local event promoters, cutting their promotion costs and the time required, while reaching the exact audience most interested in what they offer. These features will draw their participation.

The ability to learn about events of particular interest will draw the participation of individuals in towns and cities everywhere the Internet is readily available, as this channel will be easier and cheaper to monitor and potentially more comprehensive and informative, yet more selective than the traditional newspapers and other print publications, and more reliable than looking for information on physical bulletin boards. Users can select their particular interests, whether concerts or garage sales, art shows or drag races, high school basketball or children's events, and be fully informed about the relevant events through their e-mail. This service can be widely advertised and reap a great deal of positive free media attention.

As in established free e-mail services, this free and desirable flow of information can be supported by ads. With the highly localized, highly segmented, and easily identifiable audiences, local Internet advertising becomes feasible and attractive to local businesses in a new way. The ads accompanying the announcements can be from local merchants, allowing them to reach local residents in a highly targeted way based on their expressed interests. This mechanism taps the local advertising market in a way different from any other method known at this time. With this starting point it will be possible to introduce additional features of the system.

Experts: A person sending e-mail about a product or service could know a lot of people, or have a lot of people who respect their opinion in some area of culture or expertise, like bass fishing. Maybe they write for a magazine, or a website, have an ezine, or have written a book, or have a TV show, or are a celebrity in their field in some other way. They could reach a lot of people who would respect their opinion and who would be delighted to be getting e-mail from them telling them about their favorite new things. This becomes a new income source for anyone with or able to develop a circle of influence.

Personalized Gift Catalogs With Discounts: Someone could pick a ready-made catalog or compile a special gift or other catalog for an individual person, and optionally include a credit toward any purchase—in essence creating a gift certificate to a store or other provider with special features designed for that person. The gift could be money deposited as a credit to that person's account, so they could spend it any way they want or take it as cash unless the giver puts a “gift only” restriction on it, meaning it can only be spent, not taken as cash. The gift certificate could be deposited with a particular company, also, forcing use with that company, as with conventional gift certificates, or it could be created as a credit able to be used with any vendor. The credit could be restricted to a local company in the recipient's town, such as a single restaurant, store, or service provider. This possibility of getting gift certificate purchases would entice more businesses to register and make offerings through this system, including big retailers. They might compile many “gift catalogs” on various themes.

Those engaged in e-commerce already could create catalogs within the present system reflecting their other offerings, and take advantage of the other features of this system as well. Catalogs or publications could be created on specific themes, such as dresses, cat items, fishing lures, etc. Such catalogs or publications can all participate in compound marketing and other features of the system as desired by the vendor.

Applications of the Compounded Marketing System

The compounded marketing system 130 may be utilized in a variety of ways and in a variety of applications. Some of the illustrative applications are described below.

Uniting Providers and Prospects in Specialized Markets (Reclaimed Tropical Hardwoods)

This embodiment is to show how this system would work for very specialized and industrial markets.

Imagine a vendor has a source for container loads of reclaimed tropical hardwoods, cut from railroad ties that have been replaced in an Asian country, which may be used for tongue and groove flooring and the like. The selling price of a container of this material might be several thousand dollars. Likely, there are few people looking for such an item, but it may very well be interesting to a small number of consumers.

How does the vendor find them if the vendor is not in that industry? Using the methods being discussed herein, the vendor may start with a seed list and send them an offer of the product in the form of an ad module. The vendor may also find a few prospects in magazines, on the Internet, and from other sources. The vendor may send these self-discovered “seed recipients” an e-mail originating in the hub as with the seed list. It would invite them to receive information on this topic, and in addition to register with the system (if they are not already registered) and set their user profiles to receive or block categories of information as well as other parameters. If they elect to receive the e-mail related to the hardwood offer, it can include offering a commission of, for example, $500 for each container sold to someone they recommend, for a year, however many that is. There may be created, through the present invention, a website or web page with the relevant information, and a link to it in the e-mail sent by the vendor. The affiliated communications containing this offer which are sent by any registered user (affiliate) will be tracked by the present invention and the system will ensure they get credit if one of their contacts becomes a customer. Recipients of the offer can ignore it, block future e-mails in the category by creating or modifying their profile, respond with an inquiry or purchase, and/or become registered users and affiliates or use their existing status to forward the offer to others in the industry who might be interested, for possible referral fees. They can do this in the knowledge that those to whom they send it will receive no more such messages than desired, which may mean they do not receive it at all. In this way the fear of spamming can be virtually eliminated, which encourages people to forward commercial messages to those who might be interested.

The sender (at the recipient's choice) may or may not be notified if messages in such categories are blocked, as a way to increase the sender's knowledge of the recipient's interests. However some recipients may not want such information to be communicated, as their patterns of blocking or not blocking may reveal information about them they would rather keep private.

The system ensures a recipient will receive only as many offers as they have set as their limit (zero, one, or more) or if new to the system they may receive a polite invitation from the system to view an offer someone thinks they may be interested in. The product category and enough information to establish interest and credibility may be included. The sender may be able to include personalization to identify the source. When they respond the person being invited may be given easy options to refuse system e-mails in the future, and other options to be more open to offers.

The few people the vendor initially sends this e-mail to will know others in their industry, and will have reasons to pass it on or use it themselves. They, or the people they send the e-mail to, or the people those people send the e-mail to, and so on, can eventually reach a large number of potential buyers of this product if it is of real interest. Through this person to person communication an offer of interest can theoretically reach an entire community of shared interest. This is analogous to the way a towel can become soaked if any part of it is in contact with a pool of water, so this method can be called “capillary marketing” after the capillary action which soaks the towel.

Applications: Public Product Evaluations by Users:

Another quality control feature of the present invention is an optional service allowing users to post their product and service evaluations and comments. This feature would be optional for vendors to provide and there may be a cost associated with providing this feedback mechanism, but those who do allow such open evaluation would gain credibility. The dynamic would be that products with bad evaluations would tend to fail, and products not allowing public evaluations would tend to be ignored in favor of those that did.

Products, services, and/or the originator and/or immediate sender could be ranked, by way of example and not by way of limitation, numerically or in one through five star categories or in other ways by the evaluations they receive from users, with another category of ‘no rating’ for those without comments. Any other rating system may be used, as desired by the system administrator.

This public product evaluation would be another source of credibility for the system as a whole as well as for individual products and participants, and a powerful draw to using this system for shopping for physical products, services or information. It would also be a valuable source of feedback for the company selling the product and for new product designers to help identify unmet needs and needed improvements.

Application: SPAM control

The compounded marketing system 80 may be configured to inhibit unwanted communications. To start, there may be a firm no-spam policy stated in the beginning of each affiliated communication. This policy may also be presented in the user registration process, with agreement required to register. A person getting an affiliated communication who feels it was sent against their preferences may do several things that will prevent repetition:
1. Report the unwanted events to the system
2. Provide feedback from receiver to sender
3. Adjust their profile

Spam Prevention 1: Timeouts and Banishment

Spam complaints to the hub can result in giving the sender a time-out on collecting any commissions (make them lose commissions on any sales that happen from anyone they sent the affiliated communication to, for any period of time, which could escalate with repeated offenses to permanent banishment, perhaps). It could be a temporary ban on sending any affiliated communication at all (without affecting their personal e-mail).

Spam Prevention 2: Feedback to Sender

Users may “educate” the system about what they are interested in getting. By way of illustration and not limitation, there may be four levels, each of which could apply to individual senders or to the whole system. In the case of individual senders this information would go to them so they could make changes to their contact database. As another possibility, changes the recipient makes could automatically modify contact databases in which the recipient appears. The four levels mentioned are:
1. Send more information like this.
2. Refine the selection (I never buy this brand, but others are fine).
3. Drop this topic, as my interests have changed, or I have other sources I prefer.
4. Never send me anything again.

Means for providing this feedback not only to the hub in terms of updating the personal profile that it checks, but to the senders of affiliated communications as well may be provided. For example, a form (reached by a link) may be built into the system for each affiliated communication message soliciting these types of comments, with appropriate information being sent to the originating person. This form could be a mechanism for educating the hub about evolving preferences, and could at the option of the receiver be sent to the originator of the e-mail and to anyone else in his/her contact database.

It would be very effective if this feedback reached into all sender contact databases and updated the receiver's profile thereon, so the sender's record is automatically accurate. Thus if several people know a user has an interest in toy trains, but the user suddenly becomes interested only in antique toy trains, the user can update everybody at once. This keeps the senders from the effort of sending the user now-irrelevant e-mails and puts the senders on notice to be alert for anything about antique toy trains that the user might want to know about, thus improving the quality of information and the efficiency of associated actions.

Spam Prevention 3: Profile Management

All affiliated communications may be sent through the hub. Everybody, affiliated or not, and no matter who provides their e-mail, may create a profile on the hub to control the e-mail they receive through this system. They may opt out altogether and get no commercial e-mails or no e-mails at all from the system, or they may set conditions as to who may send it to them, excluding specific individuals (or their e-mail addresses), topics that are not acceptable, topics that are particularly sought, the maximum number of copies they want to get, the maximum number of e-mails to be received per day or per topic, and other parameters as may arise. This way, users can protect themselves from receiving unwanted messages, as well as ensure that they receive the messages they do want.

This profile would not be public unless the user chose to make portions of it public. Members can have, for instance, personal websites on this system that are designed to be about interests they may share with others. On these sites they can recommend the products they endorse, host discussions, etc. This is one place public portions of their profiles could be shared.

In one possible embodiment of this system a person could resist creating a profile, but would then be subject to getting unwanted affiliated communications until they create a profile, which can block them. In this sense it could be somewhat coercive, and may have many people participating out of “self-defense.” If this approach were chosen, minimizing the negative reaction would be important. One way to do this is to put the option of opting out with each of the affiliated communications in the form of a link. This would take the person to a page that would present the case for staying involved and give them several options. They could opt out at any level, from the smallest subcategory that included the e-mail they are responding to, to opting out of higher levels of category, to altogether, meaning “no commercial e-mails.” They could set up or alter their profile in any way from this page, updating it as they go along getting affiliated communications, fine tuning it to suit them at any given time.

Spam Prevention 4: A General Spam Control System Using Required Codes on Commercial E-mails

The present approach of coding e-mails that contain offerings so that any specific topic or related set of topics can be screened out or actively chosen by the recipient on the basis of the code may be utilized to implement an anti-spam system. Some known anti-spam systems may inadvertently block e-mail that is not spam. Certain groups have taken it on themselves to interfere with Internet access for companies they deem as spammers, or even having their systems set so they can be utilized by spammers. Eliminating the perceived need for and the activities of such organizations would be another benefit of an efficient and effective general spam control system. Lists of senders identified as regular sources of spam are maintained by e-mail services and transmission of e-mail from these sources is blocked. This does not serve people not on their system, it may be unfair to the senders, and it is non-selective by the intended recipients.

The coding approach of the compounded marketing system could form the basis for protecting individuals from unwanted commercial e-mail in a more comprehensive, organized way, while (in one embodiment) allowing individuals to continue to receive commercial e-mails that may be of interest to them.

### EXAMPLE 1

One embodiment of this approach provides only a negative screen.

In one embodiment, the subject line of each e-mail message that contains an offering or suggestion that one purchase something may include one or more codes, which could be alphanumeric strings. Existing e-mail programs could then be upgraded with the capacity to block e-mails with specific codes as selected by the user. Codes could be made such that a higher-level code would block all more detailed categories or subdivisions of that code.

As an alternative, another block of information could be added to the standard e-mail format equivalent to the subject line, to, from, cc, and bcc. It could be dedicated to the categorization code of the e-mail.

Individual categorization codes may be issued by the system for each e-mail message sent, and/or for each batch of e-mails sent in a mass mailing by a sender, such as an issue of a newsletter. Such codes may be encrypted. Such codes may be tracked by the system in such as way as to identify the sender, connect the sender to any complaints received, and to prevent re-use of the issued code by another sender or by the original sender. Such codes may be so designed to work with e-mail software that the categorization is displayed to the recipient in a human-readable way, allowing the recipient to sort and prioritize their e-mail efficiently by hand or by setting automatic handling routines in their e-mail program. The above is not meant to be an exhaustive list of how the system might treat e-mails, but as illustrative of the approach. Any e-mail not having a valid code specifically issued by the system may be blocked from transmission to intended recipients. It could be said that each e-mail may be licensed by the system for transmission through the system based on factors helping to ensure legitimacy as selected by the system administrator, which may include one or more of but not be limited to the known identity of the sender, origination within the system itself, and validated categorization. Categorization may be validated at different levels of assurance. The standard level might be based on software scanning the contents for correspondence with the categorization. This may include information supplied by the vendor specifically intended to develop the proper categorization. Higher level validations may be accomplished through authorized human inspection, or through a bonding arrangement with the originator, for example, and not by way of limitation. Such higher levels of accuracy assurance may be indicated to the receiver, which could be an advantage to the sender.

By selecting options related to which codes are acceptable or not, one could set his/her e-mail to block any e-mail related to commercial offers the user does not want to know about at this time through this channel. The system may be set so that one could block all coded commercial e-mail with a single selection. This method only restricts e-mail and other messages sent through the present system. For this approach to function as an effective spam filter for a recipient, a user would have to require all incoming e-mail to come through this system, which may be accomplished by using an e-mail address within the system and no others. In this way the system has a chance to inspect all e-mail going to the recipient for acceptability to the user according to the profile the user has the option of creating, and for compliance with the standards of the system. To determine acceptability, the system may require a correct categorization code on each e-mail message, which could be compared to the recipient's profile for acceptance or rejection. Further, the system would have to be able to determine with a high success rate whether e-mail is correctly coded (categorized).

Mass e-mailings of commercial offers using inappropriate codes is one tactic spammers might use as a way to get through this system. The counter could include detecting patterns of e-mailing consistent with spam, spot-checking suspected spam e-mail for correct coding, and blocking groups of e-mails sharing incriminating traits. Senders may be required to register with the system before being allowed to send, and those sending large numbers of emails may be required to prove their identity, post bonds, or take other measures to ensure accountability. Other methods could be used as well.

As another protection, the system may require that large mailings (as defined by the system administrator) to recipients using e-mail addresses in the system be sent only from registered users and/or only from a database of addresses within the system. This approach allows the system to cut off service if spam complaints are received or if prohibited behavior is detected in other ways.

The system may also require that large mailings have their categorization checked and set by either automatic or human means, or a combination of both, with systems that prevent the categorization from being changed by the sender before sending. An example of this in action would be a sender sending a coded communication to a large number of individuals in her or his database within the system, but before they are actually transmitted the system checks the e-mails using whatever means have been selected, to ensure that the proper categorization has been selected. If the categorization does not match the contents the e-mail is blocked and the sender can be contacted and whatever action deemed appropriate by the system administrator may be taken, such as restricting use of the system temporarily or permanently, without limiting the administrator's options in this regard.

To allow users in the system to continue to receive e-mail from specific senders who choose not to set up accounts within the system, if this is allowed, those senders may be provided with a code requested by the recipient, which will allow them to send e-mail to the recipient without further checking. This may be done with individuals as well as with high-volume senders.

The recipient may have the option of changing the status of such codes at any time to block further reception from that particular source, giving the recipient control over access to them. This may happen without prejudice such as labeling such e-mail as spam, as other e-mail systems require to block further reception.

Such a code could also ensure an additional degree of privacy, as the system would have no need to inspect the contents of the e-mail even by automatic means. Users could be informed of this policy if selected, which amounts to a privacy feature which many may appreciate.

Proper categorization may be made efficient for approved large senders (such as newsletter publishers) by setting them up with an automated way to get their authorized categorization codes, and this freedom to self-authorize may be accompanied by the posting of a bond or other means to encourage compliance.

By raising the difficulty of successful transmission and lowering the success rate for unrequested commercial e-mail, while at the same time offering legitimate ways to reach large numbers of responsive people, the present system tends to shift the profitable approach away from spam and toward a legitimate channel of sending to people who have expressed an interest in real time. A certain amount of unwanted commercial e-mail is from legitimate companies who use lists for lack of anything better, yet these lists may be compiled in suspect ways and may include people who would not choose to be on them, while providing no sure way for recipients to remove themselves or to change their preferences. The present system removes these problems by offering the use of real-time, opt-in lists of people specifically interested in specific topics at the time, and who have the ability to opt out safely and immediately, or to change their indicated interests, at any time. This is a user-centric system for sending commercial and non-commercial e-mail, and all else can be made subordinate to the interests of the user. This system's degree of user-centric focus, including the degree of control given to the recipient and the degree of protection of the recipient afforded by the system, are departures from other e-mail systems and represent a new opportunity for recipients to have a more useful and satisfactory experience. At the same time resistance to requested commercial messages is lowered, which may bring advertisers a greater degree of success, and the capillary effect plus the option to select categories of interest and other means provided by this system can offer advertisers a higher success rate and more return on their investment, while protecting them from any possibility of being accused of engaging in spam.

### EXAMPLE 2

For users that do not want to block all commercial e-mail, but do want to block some or most of it, coding would make it possible to ban all unwanted communication, with exceptions as desired for particular sub-topics which would be allowed through.

Applications: Waves of Support

A cooperative effort by multiple individuals to direct their commissions to a particular payee may be referred to as a support wave. When there is a disaster somewhere, the Red Cross (for example) can set up an account and everybody who wants to can log in and direct their earnings to that account. The same holds true for anybody who has a big problem that gets publicity, like a major disease or a fire—they can become the designated “reward recipient” for everybody who wants to help and is already redirecting their earnings from affiliate sales. This approach could develop into waves of support that could be directed to any particular beneficiary. The beneficiary or beneficiaries could be designated by the system for users wanting to participate in this way. A percentage or all of their earnings could be dedicated to the cause or causes selected by the system, so that no time or effort on the user's part is required to shift their funding to the chosen project. In addition or alternatively, a list of suggested beneficiaries could be made available and easily selected by individual users to receive their support, individually or in categories.

One aspect of affiliate programs that builds trust and enthusiasm, and that cuts down on administration costs, is that the affiliate can log on and see exactly how much they have earned in real time. They can get an e-mail message every time a purchase is made that credits them. They could track how much they were responsible for generating for a charity (perhaps tracked through many levels to show the cumulative effect). These features may be part of this system.

Annual awards for charity donations: Awards can be given with great fanfare, widely publicized, for the person who earned the most money for charity. This may encourage more organizations and individuals to take part. Each charity can make awards to the top earners in its own organization. Tips and examples showing how to be successful can be circulated to those who are interested. These efforts would help keep people aware of the value of this approach and draw other charities and organizations into participating.

Members can change their beneficiary at any time, redirecting their earnings as they please. This ability to partially control the stream of commerce—independently of what the company selling the product may have set up—is a feature of this system.

Applications: A Print Hybrid, the Magazine/Catalog

This embodiment starts with printed media. A positive opportunity for magazines seeking subscribers (this could include nonprofits seeking members and/or contributions) is that they can offer in their print outreach a web connection to this system. Here they may sell some set of related products, possibly at a discount, and offer free or paid subscriptions to the lite (Internet) or real (paper) version of the publication, for example. The Internet version may be the “e-mag,” with ad modules as described herein. In this way their direct mail prospecting could earn them money as people buy the product(s) featured, even if they do not subscribe.

With this approach an organization may sell something, and the further interaction and display of the benefits of and type of content in the magazine or the activities and results of a group increases the chance of a subscription or membership. Special access to purchasing a set of items chosen by the editors and/or other special benefits may become additional reasons to become a member or subscriber.

Thus, they could make an offer such as this: “If you subscribe or become a member, you will have access to our restricted website where products of particular relevance to our readers/members are available at a discount. As a prospect we are giving you limited access to, say, the featured item of the month, not to the entire selection, or to the entire selection for a limited period of time. (You can also pass on our E-mag version of this promotion to a friend, by the way, and earn $x or credit in our shop if they subscribe.)” Note that this is using other media to funnel people into the propagation system of affiliated communications.

Products in the shop could be items that are reviewed or advertised, or simply displayed in illustrations. The publication may include a code in the print magazine that refers the reader to the appropriate web reference. Such a code may include the issue and page number of the magazine, or the issue may be browsable online. This turns a regular magazine into a catalog, again expanding the income potential for print publications. Every time someone visits the online store they may have an additional chance to send an affiliated communication to their contacts featuring single items or collections of items, sharing their discoveries and possibly earning something for their effort.

It could work like this: A teenage girl gets a subscription offering to a girl's magazine in the mail. She checks out the offering of a great discount on clothes in their online store. Online she sees a piece of clothing she likes, creates an affiliated communication with an ad module about that piece, and sends it (through our hub) to a friend, saying, “I'm thinking of getting this. What do you think?” The affiliated communication may contain the same magazine subscription offering, and access to the store with the same discount. So with one mailed offering of a magazine subscription, now there are two girls exposed to it, and thinking about buying clothes in the online store associated with the magazine, and exposed to all the other inducements the sponsoring organization can offer online, which may include a free “lite” e-mag subscription that puts them in ongoing contact with these girls, through which they can sell more clothes and pitch the print magazine, for both subscriptions and newsstand sales. If they have something highly attractive to offer, the item or offer could spread rapidly through the whole “teenage girl clothes” affiliated communication network of connections. The mailed piece becomes a way to recruit a seed list, for another way to look at it.

Application: Constructing Demographics Profiles

Inferential statistics may also be used to construct demographic profiles, classify users according to demographic profile, identify buying habit and other behavior correlations among users, including but not limited to profile, level or degree of compounded marketing, and developing a greater understanding of users buying habits within a profile. Amazon and Barnes and Noble employ methods similar to this. We include this embodiment as an element in the statistical management system. Using demographics in compounded marketing distinguishes this invention from their practices. Preferably this technique would be used by a system manager to improve the degree of compounding for the business. For example, certain products may enjoy a higher level of compounding than others. A further example would be its use in developing improved ways to simplify the procedure a user must employ to pass on an affiliated link or ad module, or in finding a more effective way to present the opportunity. A system manager can make use of such information to maximize returns from the overall business.

Applications: Distributed Use

Businesses may want to use or develop their own e-mail lists and possibly their own categories with the advantages of the present system. They can be offered an arrangement whereby they can use the facilities of the present system in the context of their own website and other activities. The operation of the system would be as usual, but the interface could be modified to suit the needs of client organizations and appear on their websites. For a monthly fee or another arrangement a bookstore, for instance, could inform its interested customers of new books in the categories of their interest, announce author appearances to those interested, and the like. A bike shop could tell those interested and only those interested about bike events, new products and so on. A large Internet retailer could have modules for its products and only its products available for the use of visitors to create affiliated messages, for instance. This approach can be scaled as appropriate for any size of business or other organization.

Applications: Variable Price

Adding the capillary marketing effect and optionally the automated notification capabilities of the compounded marketing system to electronic auctions may improve effectiveness of such electronic auctions. Presently a buyer must go to the auction site and search for an item. With the addition of the present system, information about items of interest, as selected by the user, could be sent to the user for consideration.

With the present system, any person could send information to someone about an item they thought might be of interest to them. As with the rest of the system, if a category, a sender, or some other criterion set by the addressee prevented delivery of an offering, the intended recipient would be protected from receiving it. If sending the information resulted in a purchase or other desired response, the sender could earn a referral fee. This option provides a new way to earn money from auctions and a way to attract more bidders or buyers to items.

Users seeking a particular item could register with one or more auction sites using this system and indicate their interests. When an item matching their interests is posted for sale, they could be notified or sent an information module on the product, optionally linking directly to the site and allowing them to bid.

These capabilities could be provided in different ways. For example, without limiting options to these possibilities, an auction site could be provided access to the present system, or to a subset of the present system, which could be customized to the look and feel of the auction site. Then the auction site could offer its visitors, bidders, and vendors the option of creating ad modules for products or services offered and putting them into distribution through the present system, or through a subset of the present system.

In another example, bidding and/or other variable pricing capabilities may be included directly into the present system, giving it capabilities similar to or equaling an auction site, with its other capabilities in addition. In either case, the combination of bidding or other variable pricing in conjunction with the person-to-person distribution of the present system represent a new and valuable variation in finding purchasers. For example, there can be a system of decreasing the price for an item week by week or day by day until it sells, or varying demand can drive the price up and down.

Variable pricing can be built into the system as an option for any product. A provider could offer a new or used vehicle, for instance, or a piece of real estate, a business, a piece of furniture, or any item or service, either with a fixed price or, at their option, accepting bids or with any variable price scheme offered by the system, or a combination of fixed and variable pricing.. Their offer could be forwarded as an information or ad module, just as with any other offer. This method could be useful in market research such as determining the price people are willing to pay for a new product or service, or testing the effectiveness of various sales presentations, such as web page designs. Anonymity may be important in certain cases, such as when a business is offered for sale. Preferably a provision may be made for such cases.

Users could select and block categories in their interest profiles based on criteria relevant to variable price offers in addition to those previously discussed. That is, they can indicate that only products with variable or biddable prices are acceptable, or the reverse, or both, or indicate a preference, among other possible options. This can be applied to single items, categories of items, or to all items they have an interest in, or in any other useful way.

Applications: Search Engine

The compounded marketing system may be utilized in conjunction with various search engine technologies to identify items of interest. This approach, in one embodiment, may eliminate the need for categorization as such, and the need to learn a new system. In operation, a user (e.g., a prospective purchaser) may access the compounded marketing system and connect to an “interview screen.” At the interview screen, if the user enters a keyword (e.g., “car”), the user may be given successive choices about what car they want: style of car (SUV, sports car, etc.), preferred brand(s), location, cost, used or new, lease or purchase, and so on, in a logical order. The choices suggested at the interview screen may progressively narrow the criteria and the results. Some criteria could be marked as required, while other may be marked as optional (e.g., as preferences or left open). At any point the user could check search results based on the user's current choices, and continue refining if too many or the wrong kind of results are returned. The results of the search, including each intermittent choice or selection, may be stored for later use in the user's search profile or in some other form. The stored results may be designated as active or inactive by the user. The user can change the active/inactive status of the search profile at any time and modify or copy the search at any time. For example, a user may copy her previous selections of clothing size, color, and other preferences while performing a new search.

The compounded marketing system may translate results and selections of such searches into categories, e.g., in a form of an alphanumeric code embodying all the search criteria, which would make it easy for the system to scan the existing searches and offerings. This alphanumeric code could also be used by providers to code their products efficiently as offerings. For beginner providers, there may be provided a system of successive criteria-narrowing inquiries, which may be parallel to the one described for users. More experienced providers could just use the codes straight out as the expert option. The compounded marketing system may also enable a provider or any user to view particular criteria or characteristics corresponding to a particular alphanumeric code.

Applications: Access to Compounded Marketing System Available at the Sites of Others

Some or all features of the compounded marketing system may be available to user at sites (e.g. Web sites) provided independently from the compounded marketing system. This may be a facility provided to merchants in an original or a customized manner. Thus, at a site that has an arrangement with a compounded marketing system provider, a user may click a button associated with a product and be presented with a Web page or a service area that enables the user to access one or more modules associated with the product and to create and send an affiliated communication. A user may continue browsing the site, select products and add them to the affiliated communication, one by one, similar to a shopping cart. In this manner, the user may be creating a collection of desired items, which may be utilized as a gift list with a reference to the site that has the desired items for sale.

In one embodiment, the compounded marketing system may be utilized without the interest profiles or the category-checking protocol. It may be used to send affiliated communications that include modules (e.g., affiliated links) in them. The system may also be configured to allow all users to create affiliated communications, regardless of their member or affiliate status. In one embodiment, a use's status as a member or an affiliate may be recognized by the compounded marketing system even if the user utilized the system's functionality through sites independent from the compounded marketing system.

In a further embodiment, a user interface (UI) associated with compounded marketing system may be provided at a third party's site and also configured to appear as is running independently. Despite such appearance, the UI may be communicating with the main compounded marketing system site to check profiles, track emails, and perform other functions described above. Thus, the compounded marketing system may be utilized as a “send-a-friend” script adding in affiliation, database checking, profile checking, and all the backend functions.

Advantages of Compounded Marketing System

Some of the advantages provided by some embodiments of compounded marketing system include flexible allocation of referral fees and privacy protection. A database of third parties for referral fee allocation may be provided, so that anyone can choose to redirect their referral fees to anyone in the database. To protect the privacy of users in this system, communication to the user may take place without their identity or their contact information, or both, being revealed outside the system unless necessary to complete an order or the like, and with the user's permission.

Users may have the option of setting the security level for communications with the system. The system may employ any method available for improving security as default criteria set by the system manager. For example, a user may elect to have the system recognize messages only when the sending apparatus has a unique Internet ID registered in the system. The user's ID and password are additional security options. This option may be of value to users in that designating a specific apparatus reduces the possibility of misuse by others who might accidentally or otherwise come upon said user's ID.

Providers may benefit from this system by receiving market statistics, sales, feedback such as information on perceived quality of product, and user preferences for same. Providers may also receive aggregated information from user profiles, such as, for example, user's preferences.

Cash Flow

There is a cash flow advantage in this system in that it can charge vendors on a per order or per lead basis, minimizing upfront costs and risk for the provider, while placing no upper limit on system earnings. Providers can also access up-to-the-minute, focused, and highly accurate marketing information on almost any area of consumer interest, which may be provided for a fee.

Participants can enter the central coordination hub by clicking through on an e-mail message from a user, by visiting the community pages, or by accessing the main interface page. Once registered, a user can generate an e-mail message through the product communications interface B24 using the user's own information and offerings from providers. Users may also build a web page with provider offerings and information of interest; and check their personal statistics, such as how many times a certain e-mail they sent has been forwarded, how many sales are attributed to each e-mail, and the amount of commission generated for self or for a charity or other third party or parties. Participants may also visit the community pages, where they can meet to discuss and learn about various topics of interest, including specific products or classes of product, share ideas on how to succeed with affiliated communications, discuss topics of concern and generate the next ‘support wave,’ check out reviews of products or subscribe to a specific reviewer's list, check out archives, participate in any awards and recognition programs, check aggregate statistics and record-holders of other participants, visit user forums, and the like.

Interfacing with Compounded Marketing System and Methods of this Invention.

Interfacing between users and this system is preferably by electronic means, but other means such as conventional telephone, FAX, or surface mail may be used. By way of example, users can communicate with this system or its users in delayed or real time by way of e-mail, online bulletin boards, chat, forums, online discussions, Web logs (blogs), text messages, or instant messages. These means are enabled by one or more databases and/or other facilities, programs or processes necessary for these purposes. User selections, requests, referrals, and other actions may be entered into this system for processing. Preferably, users could enter a chat area and accomplish said purposes in real time. Access to this system may be by any convenient means such as a computer, a personal digital assistance (PDA), cell phone or any other means as may exist or be developed. Users could communicate affiliated links to each other through any means including but not limited to chat, online discussions, text messaging, instant messaging, bulletin boards, Web logs (blogs), and any other electronic communication means as may exist or be developed. Affiliated links could also be published in print media, which when entered in the present system would connect the user to a specific categorized product, which if responded to as desired would reward the originator of the link, if a reward is offered.

Specifically, affiliated links would be usable in online advertising venues and other pay per click arrangements.

In addition, users may have the opportunity to create individual pages which can act as a means of “pre-selling” the product or service, and may also allow the user to collect the e-mail address and other contact information of the visitor if the visitor desires to divulge that information, perhaps in exchange for something of value, such as a report or free subscription, without implying any limitation on what could be offered.

Quality Control—QC

Quality control refers the individual quality measures on given products and includes both control charting and descriptive statistics, which summarize the quantities typical of a product in question. Quality control provides the elements interrogated by the quality assurance system. Control charting is one commonly useful technique. For example, the frequency of customer returns plotted over time will typically show random variations. A control chart will pick up events or a series of events that are not likely to be random or that vary systematically with time. Preferably, QC information will include reasons for customer returns to enable more effective corrective action. Plotting histograms is a second QC technique that is useful. For example, shipping weights of items may vary such that different fractions of all shipments fall in some discrete pattern on either side of the grand average. A wide spread in weights might indicate lack of control by the supplier in question. Descriptive statistics commonly include but are not limited to the mean, standard deviation (sigma), standard error, number of items considered and their variance, which is a mathematical value, related to product variation.

Quality Assurance—QA

Quality assurance means the acquisition of information and interpretations thereof from anywhere in the entire system and reporting said interpretations in a form suitable to the system manager. For example if customer returns increase with time, this feature would be noted along with an indication of how probable this event is from past experience. For further example, if returns have historically followed a Poisson distribution, but does not during the current time period, that fact would be noted in the quality assurance report. For a further example a quality assurance report would compare actual deliveries with those promised. Statistical tools typically include but are not limited to inferential statistical tests such as but not limited to regression, ANOVA, and distribution analyses. From these and other such results, the system manager can advise suppliers of a problem to be fixed or reassure users as the case may be. Much is made of “six sigma” these days. Sigma is the standard deviation, which is a mathematical measure of observed variation in any product property. Being able to provide a product guarantee with a comfort level of six sigma gives the producer of that product tremendous leverage in the market place. A QA report can tell the system manager how close the business comes to this golden rule. If the battery in your car has a five-year rating of six sigma, you typically will not in a lifetime have your car fail to start because of battery failure. Most people will pay a premium for such assurance. This is just one example of the power of the sigma tool.

It is to be understood that embodiments of this invention may be used as or to support software programs executed upon some form of processing core (such as the CPU of a computer) or otherwise implemented or realized upon or within a machine or computer readable medium. A machine-readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information. While embodiments of the present invention will be described with reference to the Internet and the World Wide Web, the system and method described herein is equally applicable to other network infrastructures or other data communication systems.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A system to facilitate computer-based commerce, the system including:
an offering dispatch module to facilitate communicating a provider offering to a user if the offering is within a category designated by the user as being acceptable for receipt of such offering; and
a rewards module to reward the user if the user satisfies a reward criteria, the reward criteria including the user propagating the provider offering to a second user,
wherein the provider offering includes a category code to indicate an associated category for the provider offering.

2. The system of claim 1, including:
a user profile monitor to maintain a user profile, the user profile including one or more user selections from a plurality of categories, each selection associated with an area of interest;
a provider communication module to detect receipt of the provider offering; and
an offerings monitor in communication with the provider communication module to identify the offering as associated with an offering category utilizing the category code associated with the provider offering and to store the offering in an offerings database.

3. The system of claim 2, wherein the user profile includes user preferences based on one or more selections by the user responsive to one or more selections presented to the user.

4. The system of claim 1, wherein the communicating of the provider offering to the user being without revealing the user's contact information or the user's identity to the provider.

5. The system of claim 2, including a user communication module in communication with the user profile monitor to receive a selection from the user and to store the selection in the user profile, wherein the selection includes one or more of adding a category and removing a category.

6. The system of claim 5, including an intelligent agent to:
identify a related category associated with the selection of the at least one category:
identify a product associated with the related category; and
publish the associated product to the user.

7. The system of claim 6, wherein intelligent agent being to invite the user to select the related category to be included in the user profile, responsive to identifying the user as being interested in the associated product.

8. The system of claim 2, including a statistics generator to automatically generate values associated with utilization of the system.

9. The system of claim 2, wherein the user profile is stored independently from the user's communication service provider.

10. The system of claim 2, wherein the offering dispatch module is to:
detect a change to the user profile,
identify the change as an additional category in the user profile, and
enable the user to access provider offerings associated with the additional category in the user profile responsive to the change to the user profile.

11. The system of claim 1 wherein the reward criteria include a response by the second user identified as being of value to the provider.

12. The system of claim 1, wherein the reward includes one or more items selected from a group including a product, a service, an information item, a credit value, one or more points, and a monetary value.

13. The system of claim 1, wherein the reward being designated to one or more of the user and a third party.

14. The system of claim 1, including a spam control module to detect an unauthorized communication of the provider offering utilizing a permission code associated with the provider offering.

15. The system of claim 14, wherein the spam control module is to receive a spam complaint, and to initiate an action in response to the spam complaint.

16. The system of claim 1, including a variable price component to allow the price for an offering to vary.

17. A system including:
a user search profile component to modify a user preference profile based on a request from a user and on a selection of one or more characteristics associated with the request;
an offering profile component to generate an offering profile based on one or more selections characteristics of the offering; and
a matching component to identify an entry from the user preference profile as corresponding to an entry from the offering profile.

18. A method to facilitate computer-based commerce, the method including:
communicating a provider offering to a user if the offering is within a category designated by the user as being acceptable for receipt of such offering; and
rewarding the user if the user satisfies a reward criteria, the reward criteria including the user propagating the provider offering to a second user,
wherein the provider offering includes a category code to indicate an associated category for the provider offering.

19. The method of claim 18, further including:
maintaining a user profile, the user profile including one or more user selections from a plurality of categories, each selection associated with an area of interest;
detecting receipt of the provider offering; and
identifying the offering as associated with an offering category utilizing the category code associated with the provider offering and to store the offering in an offerings database.

20. The method of claim 19, further including receiving user preferences based on one or more selections by the user responsive to one or more selections presented to the user.

21. The method of claim 18, wherein the communicating of the provider offering to the user being without revealing the user's contact information or the user's identity to the provider.

22. The method of claim 19, including receiving a selection from the user and storing the selection in the user profile, wherein the selection includes one or more of adding a category and removing a category.

23. The method of claim 22, further including:
identifying a related category associated with the selection of the at least one category:
identifying a product associated with the related category; and
publishing the associated product to the user.

24. The method of claim 23, further including inviting the user to select the related category to be included in the user profile, responsive to identifying the user as being interested in the associated product.

25. The method of claim 19, further including:
detecting a change to the user profile,
identifying the change as an additional category in the user profile, and
enabling the user to access provider offerings associated with the additional category in the user profile responsive to the change to the user profile.

26. The method of claim 18, further including detecting an unauthorized communication of the provider offering utilizing a permission code associated with the provider offering.

27. The method of claim 18, further including modifying the price for an offering according to a predetermined criteria.

28. An apparatus including:
means for communicating a provider offering to a user if the offering is within a category designated by the user as being acceptable for receipt of such offering; and
means for rewarding the user if the user satisfies a reward criteria, the reward criteria including the user propagating the provider offering to a second user,
wherein the provider offering includes a category code to indicate an associated category for the provider offering.

29. A user interface including:
an item display area to display an item;
an affiliated communication creation area to:
enable a user to create one or more affiliated communications including content associated with the product, and
enable the user to qualify for a reward if the user satisfies a reward criteria, the reward criteria including the user propagating the provider offering to a second user; and
a control button associated with the item to enable a user to access the affiliated communication creation area.

30. A machine-readable medium having stored thereon data representing sets of instructions which, when executed by a machine, cause the machine to:
facilitate communicating a provider offering to a user if the offering is within a category designated by the user as being acceptable for receipt of such offering; and
reward the user if the user satisfies a reward criteria, the reward criteria including the user propagating the provider offering to a second user,
wherein the provider offering includes a category code to indicate an associated category for the provider offering.
